(19) United States
(12) Patent Application Publication
(10) Pub. No.: US 2026/0360148 A1
(43) Pub. Date: Nov. 12, 2026

(54) SYSTEMS AND METHODS FOR AN EDGE AI SENSOR NETWORK

(71) Applicant: PLUME DESIGN, INC., Palo Alto, CA (US)

(72) Inventors: Richard CHANG, Los Altos Hills, CA (US); MingShu LIU, Hsinchu (TW); JianShing LI, Campbell, CA (US); Miroslav SAMARDZIJA, Mountain View, CA (US); Dinh Hieu Liem VO, Saratoga, CA (US); Ha DO, Cumming, GA (US); Jeffrey CHAO, San Jose, CA (US); Cuong VU, Newark, CA (US)

(21) Appl. No.: 19/299,553

(22) Filed: Aug. 14, 2025

Related U.S. Application Data
(60) Provisional application No. 63/804,604, filed on May 12, 2025.

(51) Int. Cl. G06V 20/40; G06F 40/30

(52) U.S. Cl. CPC G06V 20/47; G06F 40/30; G06V 20/41

(57) ABSTRACT

Disclosed are computerized systems and methods for a decision intelligence (DI)-based framework that automatically and/or dynamically provides mechanisms for managing, optimizing and configuring a wireless network at a location. The framework provides distributed edge computing mechanisms for smart home network and device management. The framework can perform localized real-time video analysis, automated device classification, intelligent sensor network management, and advanced content filtering without requiring cloud dependencies. Such distributed architecture employs elastic edge computing principles to dynamically allocate processing tasks across available devices, utilizing containerized deployment mechanisms for secure application management and federated learning capabilities that enhance local AI models with collective insights while maintaining complete data privacy. In some implementations, the framework's orchestration functions to intelligently manage computing resources across multiple nodes, enabling parallel processing of complex AI tasks while accommodating existing device functions, creating a fault-tolerant system that scales based on demand, and/or location and/or network characteristics.

### CROSS-REFERENCE TO RELATED APPLICATIONS

This application claims the benefit of priority from U.S. Provisional Application No. 63/804,604, filed May 19, 2025, whereby the contents of which are incorporated by reference in its entirety.

### FIELD OF THE DISCLOSURE

The present disclosure provides a decision intelligence (DI)-based computerized framework for automatically and/or dynamically managing, optimizing and configuring a wireless network at a location.

### SUMMARY OF THE DISCLOSURE

According to some embodiments, as discussed herein, the disclosed systems and methods provide a computerized, network management and configuration framework that operates by utilizing edge processing capabilities to bridge local Wireless Fidelity (Wi-Fi or WiFi, used interchangeably) and cloud systems.

According to some embodiments, as evidenced from the disclosure herein, the disclosed framework represents a paradigm shift in smart home artificial intelligence (AI) and network/device management, by implementing a distributed edge computing architecture that transforms existing home network infrastructure into an intelligent, adaptive system. Rather than relying on cloud-based processing, the framework can leverage the computational resources already present in modern homes—including Wi-Fi routers, mesh nodes, set-top boxes, and other connected devices—to create a localized AI processing cluster that operates with minimal latency and enhanced privacy protection.

In some embodiments, the framework can establish what may be termed “elastic edge computing,” where AI workloads are dynamically distributed across available home devices based on computational capacity and current load. Such approach can enable the framework to scale processing power incrementally as new devices join the network, while maintaining fault tolerance through distributed redundancy. In some embodiments, the framework can orchestrate these resources through an advanced coordination mechanism that treats each participating device as a node in a local compute cluster, effectively creating a miniaturized cloud environment within the home.

In some embodiments, the technical architecture of the framework can support multiple AI-driven applications simultaneously, including personalized Wi-Fi optimization, device classification and management, advanced parental controls, occupancy sensing through Wi-Fi signal analysis, and comprehensive Internet of Things (IoT) automation. Each of these applications can benefit from the framework's ability to process data locally, enabling real-time responses while maintaining data privacy by keeping sensitive information within the home environment.

In some embodiments, the framework can implement federated learning principles, where local AI models train on household-specific data while contributing anonymized insights to a broader knowledge base. Such approach can enable the framework to benefit from collective learning across multiple deployments while preserving individual privacy. In some embodiments, local models can adapt to specific household patterns and preferences, while periodic synchronization with cloud-based aggregated models can enhance overall system intelligence without compromising personal data security.

According to some embodiments, from a deployment perspective, the framework can operate on existing hardware through containerized applications, eliminating the need for specialized AI processing units or extensive hardware upgrades. In some embodiments, the framework can run efficiently on standard router processors, leveraging spare computational cycles during periods of low network activity. Such hardware-agnostic approach can enable widespread deployment across diverse device ecosystems without requiring significant infrastructure investment.

In some embodiments, the framework's modular architecture can support extensibility through well-defined APIs and integration points, allowing third-party applications to leverage the distributed computing infrastructure and sensor data streams. Such extensibility can enable service providers to develop custom applications tailored to specific market segments or user requirements while maintaining the core intelligence and optimization capabilities of the underlying platform.

According to some embodiments, it should be understood that reference to a location can refer to any type of known or to be known geographic area, building, structure or area for which wireless connectivity can be provided, which can include, but is not limited to, a home, office, building, patio, and the like, without departing from the scope of the instant disclosure.

Accordingly, as discussed herein, in some embodiments, the disclosed framework can implement a comprehensive distributed edge AI infrastructure that transforms conventional network devices into an intelligent processing ecosystem capable of performing sophisticated artificial intelligence operations entirely within the local network boundary. In some embodiments, the framework can leverage the computational resources inherent in modern network infrastructure —including Wi-Fi access points, mesh nodes, set-top boxes, smart televisions, and connected devices—to create a localized AI processing cluster that performs real-time (or near real-time) video analysis, automated device classification, intelligent sensor network management, and advanced content filtering without requiring cloud dependencies. Such distributed architecture employs elastic edge computing principles to dynamically allocate processing tasks across available devices, utilizing containerized deployment mechanisms for secure application management and federated learning capabilities that enhance local AI models with collective insights while maintaining complete data privacy. In some embodiments, the framework's orchestration component intelligently manages computing resources across multiple nodes, enabling parallel processing of complex AI tasks while accommodating existing device functions, creating a fault-tolerant system that scales processing power according to demand and provides improved latency, robustness, and cost-effectiveness compared to cloud-dependent alternatives.

According to some embodiments, a method is disclosed for automatically and/or dynamically managing, optimizing and configuring a wireless network at a location. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for automatically and/or dynamically managing, optimizing and configuring a wireless network at a location.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 illustrates an exemplary workflow according to some embodiments of the present disclosure;

FIG. 5 illustrates an exemplary workflow according to some embodiments of the present disclosure;

FIG. 6 illustrates an exemplary workflow according to some embodiments of the present disclosure;

FIG. 7 depicts an exemplary implementation of an architecture according to some embodiments of the present disclosure;

FIG. 8 depicts an exemplary implementation of an architecture according to some embodiments of the present disclosure; and

FIG. 9 is a block diagram illustrating a computing device showing an example of a client or server device used in some embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that the claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some embodiments, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth™, 802.11b/a/g/n/ac/ax/be, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures.

According to some embodiments, as discussed herein, disclosed is a distributed edge computing framework for smart home network and device management. In some embodiments, the framework leverages existing home network infrastructure—including Wi-Fi routers, mesh nodes, and connected devices—to form a localized, elastic computing cluster capable of executing AI workloads with low latency and enhanced privacy. AI tasks are dynamically allocated across devices based on real-time capacity, enabling scalable processing and fault tolerance. The framework supports multiple simultaneous applications such as personalized Wi-Fi optimization, device classification, occupancy sensing, and IoT automation, with local data processing ensuring privacy. Federated learning allows local models to adapt to household-specific data while contributing anonymized updates to a shared knowledge base. In some embodiments, the framework can function on standard hardware using containerized applications and exposed modular APIs for third-party integration, facilitating broad deployment without requiring specialized hardware upgrades.

### Video Content Analysis and Image Processing

In some embodiments, the framework can leverage the distributed edge computing architecture described in the underlying technology to transform real-time video content analysis from a cloud-dependent process into a localized, intelligent system that operates within the confines of a location's network infrastructure. The framework can utilize the computational resources already present in modern homes and offices—including Wi-Fi routers, mesh nodes, set-top boxes, smart televisions, and other connected devices—to create an advanced AI processing cluster capable of performing comprehensive video analysis with minimal latency and enhanced privacy protection. This approach represents a fundamental shift from traditional cloud-based video processing, where sensitive visual data must be transmitted to external servers for analysis, to a model where all image processing occurs locally within the network boundary.

In some embodiments, the framework can implement what may be termed “elastic edge video processing,” where AI workloads related to video content analysis are dynamically distributed across available devices within the location based on their computational capacity, current processing load, and specialized capabilities. The framework can orchestrate these resources through an advanced coordination mechanism that treats each participating device as a specialized node in a local compute cluster, effectively creating a miniaturized cloud environment optimized for video processing tasks. This distributed approach enables the framework to scale processing power incrementally as new devices join the network while maintaining fault tolerance through distributed redundancy, ensuring that video analysis capabilities remain available even if individual devices experience failures or become temporarily unavailable.

In some embodiments, the framework can establish a multi-tiered processing hierarchy where different aspects of video content analysis are assigned to devices based on their computational strengths and current availability. For example, the framework can assign initial frame capture and basic preprocessing tasks to set-top boxes or smart televisions that have direct access to video streams, while more computationally intensive tasks such as object recognition, facial identification, and contextual analysis can be distributed to more powerful devices within the network, such as mesh router nodes or dedicated edge computing devices. This hierarchical approach enables the framework to optimize resource utilization while maintaining the real-time responsiveness required for interactive video analysis applications.

### Local Image Capture and Processing Pipeline

In some embodiments, the framework can implement an advanced image capture mechanism that operates continuously in the background while users consume video content. The framework can maintain a rolling buffer of recent video frames across multiple devices, ensuring seamless capture capabilities without interrupting the viewing experience or imposing significant storage requirements on individual devices. This distributed buffering approach enables the framework to capture high-quality frames at the exact moment of user interaction while also maintaining contextual frames from preceding and following time periods, providing comprehensive scene information for subsequent analysis.

In some embodiments, the framework can perform intelligent frame selection algorithms that operate locally within the network to identify the most suitable frames for analysis. These algorithms can consider multiple factors including frame rate, image quality, motion blur characteristics, lighting conditions, and the presence of identifiable elements within the scene. The framework can analyze temporal sequences to identify key frames that contain the most relevant information while filtering out frames that may be compromised by motion artifacts, poor lighting, or other quality issues that could impair subsequent analysis accuracy.

In some embodiments, the framework can implement advanced preprocessing capabilities that prepare captured frames for analysis by the local large language model (LLM) and computer vision systems. This preprocessing can include image enhancement techniques such as noise reduction, contrast adjustment, and sharpening to improve the quality of input data for subsequent analysis stages. The framework can perform automatic color correction, exposure adjustment, and other image optimization techniques to ensure that captured frames are in optimal condition for entity recognition and classification tasks.

In some embodiments, the framework can segment captured frames into regions of interest using local computer vision algorithms, identifying distinct areas within the image that may contain relevant entities such as people, objects, locations, or text. This segmentation process can operate as a preliminary filtering mechanism, allowing the framework to focus subsequent analysis resources on the most promising areas of the image while reducing computational overhead and improving processing efficiency. The framework can maintain confidence scores for each identified region, enabling prioritization of analysis efforts based on the likelihood of successful entity identification.

### Local Large Language Model Integration

In some embodiments, the framework can integrate advanced large language model capabilities that operate entirely within the local network infrastructure, eliminating the need to transmit sensitive image data to external cloud services for analysis. The framework can deploy containerized LLM applications across multiple devices within the network, creating a distributed inference system that can process visual content while maintaining complete data privacy and security. This local LLM integration enables the framework to perform complex reasoning tasks about visual content, including contextual analysis, relationship identification, and semantic understanding of scene composition.

In some embodiments, the framework can implement federated learning principles where local LLM models continuously adapt and improve based on household-specific or location-specific usage patterns and preferences. The framework can train these models on locally generated data while contributing anonymized insights to broader knowledge bases, enabling continuous improvement of analysis capabilities without compromising individual privacy. Local models can learn to recognize recurring entities, understand user preferences for different types of content analysis, and adapt their processing approaches based on the specific characteristics of the location's viewing patterns and content consumption habits.

In some embodiments, the framework can perform multi-modal analysis where the local LLM processes both visual and contextual information to provide comprehensive understanding of video content. The framework can analyze relationships between identified entities, temporal context from surrounding frames, spatial relationships within scenes, and interaction patterns between different elements. This contextual analysis capability enables the framework to provide more meaningful insights about scene composition and entity relationships than would be possible through simple object recognition alone.

In some embodiments, the framework can implement specialized LLM models optimized for different types of video content analysis tasks. The framework can deploy models specifically trained for facial recognition and identification, others optimized for object and product recognition, and additional models focused on location and landmark identification. This specialization approach enables the framework to achieve higher accuracy and efficiency in specific analysis domains while maintaining the flexibility to handle diverse types of video content and user requests.

### Query Generation and External Communication

In some embodiments, the framework can implement advanced query generation mechanisms that transforms the results of local image analysis into structured queries that can be transmitted to external databases and services without revealing sensitive visual information. After performing comprehensive local analysis of captured frames, the framework can generate semantic queries that describe identified entities, their characteristics, and their relationships in abstract terms rather than transmitting raw image data or detailed visual descriptions. This approach enables the framework to leverage external knowledge bases and databases while maintaining strict privacy protection for visual content.

In some embodiments, the framework can perform intelligent query optimization where multiple identified entities from a single frame or sequence of frames are combined into efficient, consolidated queries that minimize external network traffic while maximizing the information retrieved. The framework can analyze the relationships between identified entities to determine which queries are most likely to provide relevant supplemental information, prioritizing queries based on user interests, previous interaction patterns, and the confidence levels of entity identifications. This optimization process ensures that external communications remain minimal and focused on the most valuable information requests.

In some embodiments, the framework can implement privacy-preserving query techniques that further abstract the specific details of identified entities while still enabling effective information retrieval. For example, rather than querying for a specific person's identity, the framework can generate queries about general categories of individuals, professions, or roles that match the characteristics identified through local analysis. Similarly, for product identification, the framework can query for categories of items with specific attributes rather than requesting identification of exact products, enabling retrieval of relevant information while maintaining privacy protection.

In some embodiments, the framework can perform query result caching and intelligent prefetching to minimize the frequency of external communications while maintaining responsive user experiences. The framework can cache results from previous queries and intelligently predict which additional information may be needed based on identified entities and user interaction patterns. This caching mechanism enables the framework to provide immediate responses to user requests for supplemental information while reducing the overall volume of external network communications.

### Privacy-Preserving Processing Architecture

In some embodiments, the framework can implement comprehensive privacy protection mechanisms that ensure sensitive visual information never leaves the local network boundary. All image processing, entity recognition, and analysis tasks can be performed using local computational resources, with only abstract, non-identifying queries transmitted to external services. The framework can maintain strict data isolation protocols that prevent any visual data from being stored, transmitted, or processed outside the local network environment, ensuring that personal and private information captured in video content remains completely secure.

In some embodiments, the framework can implement differential privacy techniques in its query generation processes, adding controlled noise to queries to prevent potential inference attacks while maintaining the utility of retrieved information. The framework can analyze the potential privacy implications of different query formulations and automatically adjust query specificity to minimize the risk of revealing sensitive information about individuals, locations, or activities captured in video content. This privacy-preserving approach enables the framework to benefit from external knowledge sources while maintaining rigorous protection of personal information.

In some embodiments, the framework can provide users with granular privacy controls that allow configuration of analysis types, information sharing preferences, and external communication parameters. Users can specify which types of entities should be analyzed, which categories of supplemental information can be requested from external sources, and which types of queries are permitted to be transmitted outside the local network. The framework can implement these privacy preferences as enforceable policies that govern all aspects of the video analysis and information retrieval processes.

In some embodiments, the framework can implement secure multi-party computation techniques that enable collaborative analysis across multiple devices within the network while maintaining data privacy and security. Different devices can contribute to the analysis process without sharing raw data, instead exchanging only intermediate results or aggregated information necessary for comprehensive entity identification and contextual analysis. This distributed approach enables the framework to leverage the full computational capacity of the local network while maintaining strict data isolation and privacy protection.

### Real-Time Performance and Responsiveness

In some embodiments, the framework can achieve real-time performance characteristics that enable immediate responsiveness to user inputs while maintaining the quality and comprehensiveness of analysis results. The framework can implement low-latency processing pipelines that can capture, analyze, and generate queries for video content within milliseconds of user interaction, ensuring that the video analysis experience feels immediate and natural. This real-time capability is enabled by the distributed processing architecture and local LLM integration, which eliminates the network delays and processing queues associated with cloud-based analysis systems.

In some embodiments, the framework can implement predictive processing capabilities that anticipate user interests and begin analysis of relevant content before explicit user requests. The framework can analyze viewing patterns, interaction history, and content characteristics to predict which entities within video content are most likely to be of interest to users, enabling proactive analysis that further reduces response times. This predictive approach enables the framework to provide immediate results when users request information about video content, as the analysis has already been completed in anticipation of the request.

In some embodiments, the framework can perform incremental processing where analysis results are continuously updated and refined as additional computational resources become available. Initial analysis results can be provided immediately based on fast, lightweight processing, while more detailed and comprehensive analysis continues in the background using additional computational resources. This incremental approach enables the framework to provide immediate user feedback while continuously improving the quality and completeness of analysis results.

In some embodiments, the framework can implement adaptive quality controls that automatically adjust the depth and complexity of analysis based on available computational resources and user response time requirements. During periods of high network activity or limited computational availability, the framework can focus on essential analysis tasks while deferring more detailed processing to times when additional resources are available. This adaptive approach ensures that the framework maintains responsive performance characteristics regardless of varying network conditions and computational demands.

### Integration with Existing Network Infrastructure

In some embodiments, the framework can operate seamlessly within existing network infrastructure without requiring specialized hardware or extensive modifications to current device configurations. The framework can deploy as containerized applications that can run on standard router processors, set-top boxes, and other connected devices, leveraging spare computational cycles during periods of low network activity. This hardware-agnostic approach enables widespread deployment across diverse device ecosystems without requiring significant infrastructure investment or technical expertise from end users.

In some embodiments, the framework can implement intelligent resource management that monitors network performance and automatically adjusts processing loads to maintain optimal network functionality. The framework can detect when network resources are being heavily utilized for primary functions such as internet connectivity, streaming, or file transfers, and automatically scale back video analysis processing to ensure that core network services remain unaffected. This resource management approach enables the framework to provide advanced video analysis capabilities while maintaining the reliability and performance of essential network functions.

In some embodiments, the framework can provide seamless integration with existing video consumption platforms and devices, enabling video analysis capabilities to be added to current viewing experiences without requiring changes to content delivery systems or user interfaces. The framework can operate as a transparent overlay that enhances existing video content without interfering with normal viewing activities, providing additional capabilities that users can access when desired while maintaining the familiar and expected video consumption experience.

In some embodiments, the framework can implement backward compatibility mechanisms that ensure functionality across different generations of network equipment and connected devices. The framework can automatically detect the capabilities of available devices and adjust its processing distribution accordingly, ensuring that older devices can contribute to the analysis process within their capabilities while newer devices can take on more computationally intensive tasks. This compatibility approach enables the framework to provide value across diverse technology environments while encouraging gradual upgrades that can enhance overall system capabilities.

### Scalability and Extensibility

In some embodiments, the framework can implement modular architecture that supports extensibility through well-defined APIs and integration points, enabling the addition of new analysis capabilities, content sources, and interaction mechanisms without requiring fundamental changes to the core system. The framework can support plugin architectures that allow third-party developers to create specialized analysis modules, custom user interfaces, and integration capabilities with external services and databases. This extensible approach enables the framework to evolve with advancing technology and changing user needs while maintaining compatibility with existing deployments.

In some embodiments, the framework can perform automatic scaling of processing capabilities as new devices join the network, incrementally increasing the sophistication and speed of video analysis operations. The framework can detect when new computational resources become available and automatically distribute additional processing tasks to these resources, enabling continuous improvement of analysis capabilities without requiring manual configuration or system reconfiguration. This automatic scaling approach ensures that the framework can take full advantage of evolving home and office technology environments.

In some embodiments, the framework can implement cross-network collaboration capabilities that enable multiple location-based frameworks to share non-sensitive analytical insights and processing improvements while maintaining complete privacy protection for individual video content. The framework can participate in federated learning networks where aggregated insights about entity recognition accuracy, query optimization techniques, and user interaction patterns can be shared to improve overall system performance across multiple deployments. This collaborative approach enables continuous improvement of framework capabilities while preserving the privacy and security advantages of local processing.

In some embodiments, the framework can provide comprehensive analytics and performance monitoring capabilities that track system performance, user satisfaction, and analysis accuracy across different types of video content and usage patterns. The framework can generate detailed reports about processing efficiency, resource utilization, and user engagement patterns that can inform system optimization and feature development decisions.

### Distributed Image Processing

In some embodiments, the framework can implement advanced image processing capabilities that operate as a distributed sensor network within a location's existing network infrastructure, transforming traditional security and monitoring applications into intelligent, adaptive systems capable of comprehensive scene analysis and person identification. The framework can leverage the computational resources already present in modern network environments—including Wi-Fi access points, mesh nodes, and connected devices—to create a localized AI processing cluster that can analyze visual data from multiple camera sources with minimal latency and enhanced privacy protection. This approach represents a fundamental departure from cloud-dependent image processing systems, enabling real-time visual analysis while maintaining complete data sovereignty within the network boundary.

In some embodiments, the framework can establish what may be termed “elastic edge image processing,” where AI workloads related to visual analysis are dynamically distributed across available network devices based on their computational capacity, current processing load, and specialized capabilities. The framework can orchestrate these resources through an advanced coordination mechanism that treats each participating device as a specialized node in a local compute cluster, effectively creating a miniaturized cloud environment optimized for image processing tasks. This distributed approach enables the framework to scale processing power incrementally as new devices join the network while maintaining fault tolerance through distributed redundancy, ensuring that image processing capabilities remain available even if individual devices experience failures or become temporarily unavailable.

In some embodiments, the framework can implement a multi-tiered processing hierarchy where different aspects of image analysis are assigned to devices based on their computational strengths and current availability. For example, the framework can assign initial image capture and basic preprocessing tasks to camera devices and edge nodes, while more computationally intensive tasks such as scene detection, person identification, and behavioral analysis can be distributed to more powerful devices within the network, such as Wi-Fi access points or dedicated edge computing devices. This hierarchical approach enables the framework to optimize resource utilization while maintaining the real-time responsiveness required for security and monitoring applications.

### Scene Detection and Analysis Capabilities

In some embodiments, the framework can perform comprehensive scene detection that goes beyond simple motion detection to provide detailed understanding of activities and events occurring within monitored areas. The framework can analyze visual scenes to identify specific activities, behavioral patterns, and environmental changes that may be relevant for security, safety, or operational purposes. This scene analysis capability can distinguish between normal activities and potentially concerning events, enabling intelligent alerting and response systems that minimize false alarms while ensuring that significant events are properly identified and reported.

In some embodiments, the framework can implement contextual scene understanding that considers temporal patterns, environmental conditions, and historical data to provide more accurate and meaningful analysis of visual information. The framework can learn normal activity patterns for specific locations and time periods, enabling it to identify anomalies or unusual events that may require attention. This contextual analysis capability enables the framework to adapt to different environments and usage patterns, providing customized monitoring and analysis that reflects the specific characteristics and requirements of each location.

In some embodiments, the framework can perform multi-camera scene correlation where visual data from multiple camera sources is analyzed collectively to provide comprehensive understanding of activities across larger areas. The framework can track movement patterns, identify relationships between events occurring in different locations, and provide unified analysis that considers the broader context of activities within the monitored environment. This multi-camera capability enables the framework to provide more comprehensive security coverage while reducing the computational overhead associated with independent analysis of each camera stream.

In some embodiments, the framework can implement intelligent scene classification that can identify different types of environments, activities, and situations based on visual analysis. The framework can distinguish between indoor and outdoor scenes, identify specific room types or functional areas, and recognize different categories of activities such as routine daily activities, social gatherings, or potential security concerns. This classification capability enables the framework to apply appropriate analysis algorithms and response protocols based on the specific characteristics of each scene and situation.

### Person Identification and Recognition

In some embodiments, the framework can perform advanced person identification that operates entirely within the local network infrastructure, eliminating the need to transmit sensitive biometric data to external cloud services for analysis. The framework can deploy containerized AI applications across multiple devices within the network, creating a distributed inference system that can process facial recognition and person identification tasks while maintaining complete data privacy and security. This local person identification capability enables the framework to maintain detailed records of individuals accessing monitored areas while ensuring that sensitive biometric information never leaves the network boundary.

In some embodiments, the framework can implement federated learning principles where local person identification models continuously adapt and improve based on location-specific usage patterns and individual characteristics. The framework can train these models on locally generated data while contributing anonymized insights to broader knowledge bases, enabling continuous improvement of identification accuracy without compromising individual privacy. Local models can learn to recognize authorized individuals, understand normal behavioral patterns, and adapt their identification approaches based on the specific characteristics of the location's occupants and visitors.

In some embodiments, the framework can perform multi-modal person identification that combines facial recognition with other identifying characteristics such as gait analysis, clothing recognition, and behavioral pattern analysis. The framework can analyze movement patterns, posture characteristics, and other distinctive features that can aid in person identification even when facial features are not clearly visible or available. This multi-modal approach enables the framework to provide more robust and accurate person identification capabilities while maintaining effectiveness in challenging lighting conditions or when individuals are partially obscured.

In some embodiments, the framework can implement privacy-preserving person identification techniques that enable recognition and tracking of individuals without storing or transmitting detailed biometric data. The framework can generate abstract identity tokens or signatures that enable tracking and recognition while protecting the underlying biometric information from unauthorized access or disclosure. This privacy-preserving approach enables the framework to provide effective security monitoring while maintaining strict protection of personal information and biometric data.

### Computational Efficiency and Resource Management

In some embodiments, the framework can achieve remarkable computational efficiency that enables advanced image processing on standard network hardware without requiring specialized AI processing units or extensive hardware upgrades. The framework can perform person detection at approximately 1.2 frames per second using a memory footprint of only 23 megabytes and consuming 106 megabytes of RAM while utilizing 83% of a single CPU core. Given that typical Wi-Fi access points have four or more CPU cores, this computational requirement represents a manageable load even for lower-end network devices, enabling widespread deployment across diverse hardware environments.

In some embodiments, the framework can implement intelligent resource management that monitors network performance and automatically adjusts image processing loads to maintain optimal network functionality. The framework can detect when network resources are being heavily utilized for primary functions such as internet connectivity, data routing, or file transfers, and automatically scale back image processing activities to ensure that core network services remain unaffected. This resource management approach enables the framework to provide advanced image processing capabilities while maintaining the reliability and performance of essential network functions.

In some embodiments, the framework can perform adaptive quality controls that automatically adjust the complexity and frequency of image analysis based on available computational resources and current network conditions. During periods of high network activity or limited computational availability, the framework can focus on essential monitoring tasks while deferring more detailed analysis to times when additional resources are available. This adaptive approach ensures that the framework maintains effective security monitoring regardless of varying network conditions and computational demands.

In some embodiments, the framework can implement efficient processing pipelines that minimize computational overhead while maintaining high accuracy in scene detection and person identification tasks. The framework can utilize optimized algorithms, hardware acceleration where available, and intelligent caching mechanisms to reduce the computational burden of image processing while ensuring that analysis results meet the accuracy and reliability requirements of security and monitoring applications.

### Integration with Security and Monitoring Systems

In some embodiments, the framework can integrate seamlessly with existing security and monitoring infrastructure, providing enhanced AI capabilities without requiring replacement of current camera systems or security equipment. The framework can operate as an intelligent overlay that enhances existing security systems with advanced scene analysis and person identification capabilities, providing additional functionality that can be accessed when needed while maintaining compatibility with established security protocols and procedures.

In some embodiments, the framework can implement intelligent alerting systems that can distinguish between routine activities and events that require attention, significantly reducing false alarms while ensuring that legitimate security concerns are properly identified and reported. The framework can analyze the context and characteristics of detected events to determine appropriate response levels, enabling customized alerting that reflects the specific security requirements and operational characteristics of each location.

In some embodiments, the framework can provide comprehensive event logging and analysis capabilities that maintain detailed records of detected activities, identified individuals, and system responses. The framework can generate reports about security events, system performance, and identification accuracy that can inform security management decisions and system optimization efforts. This logging capability enables continuous improvement of security effectiveness while providing valuable insights into activity patterns and system performance.

In some embodiments, the framework can implement automated response capabilities that can trigger appropriate actions based on detected events and identified individuals. The framework can integrate with access control systems, lighting controls, communication systems, and other connected devices to provide coordinated responses to security events. This automation capability enables the framework to provide proactive security management while reducing the burden on security personnel and improving overall response effectiveness.

### Federated Learning and Cloud Integration

In some embodiments, the framework can implement federated learning capabilities that enable continuous improvement of image processing accuracy through collaboration with cloud-based knowledge systems while maintaining complete privacy protection for local image data. The framework can participate in federated learning networks where aggregated insights about scene detection accuracy, person identification techniques, and environmental adaptation strategies can be shared to improve overall system performance across multiple deployments. This collaborative approach enables continuous improvement of framework capabilities while preserving the privacy and security advantages of local processing.

In some embodiments, the framework can perform selective knowledge sharing where non-sensitive insights about processing techniques, algorithm optimization, and performance improvements can be contributed to broader knowledge bases without revealing specific information about individuals, locations, or activities. The framework can analyze the privacy implications of different types of information sharing and automatically filter shared data to ensure that sensitive information remains protected while still enabling valuable contributions to collective learning efforts.

In some embodiments, the framework can implement cloud-enhanced local learning where insights from federated learning networks are used to improve local processing capabilities without requiring transmission of sensitive data to external systems. The framework can receive updated models, algorithm improvements, and optimization techniques from cloud-based systems while maintaining complete local control over image processing and analysis activities. This approach enables the framework to benefit from collective knowledge while maintaining the privacy and security advantages of local processing.

### Device Classification

In some embodiments, the framework can implement advanced device classification capabilities that operate as an intelligent profiling system within a location's network infrastructure, automatically categorizing personal devices into distinct user profiles such as child and adult classifications. The framework can leverage the distributed edge computing architecture to continuously analyze device behaviors, internet consumption patterns, and usage characteristics without requiring transmission of sensitive data to external cloud services. This approach represents a fundamental shift from traditional device management systems that rely on manual configuration or cloud-based analysis, enabling automated, adaptive, and privacy-preserving device classification that operates within the local network boundary.

In some embodiments, the framework can establish what may be termed “elastic edge device profiling,” where AI workloads related to device behavior analysis are dynamically distributed across available network devices based on their computational capacity, current processing load, and data access capabilities. The framework can orchestrate these resources through an advanced coordination mechanism that treats each participating device as a specialized node in a local compute cluster, effectively creating a miniaturized cloud environment optimized for behavioral analysis and pattern recognition tasks. This distributed approach enables the framework to scale processing power incrementally as new devices join the network while maintaining fault tolerance through distributed redundancy, ensuring that device classification capabilities remain available even if individual devices experience failures or become temporarily unavailable.

In some embodiments, the framework can implement a multi-tiered processing hierarchy where different aspects of device classification are assigned to network components based on their computational strengths and data access privileges. For example, the framework can assign initial data collection and aggregation tasks to Wi-Fi access points and mesh nodes that have direct visibility into network traffic patterns, while more computationally intensive tasks such as behavioral pattern analysis, machine learning inference, and profile generation can be distributed to more powerful devices within the network. This hierarchical approach enables the framework to optimize resource utilization while maintaining the real-time responsiveness required for dynamic device classification and management applications.

### Comprehensive Data Collection and Analysis Pipeline

In some embodiments, the framework can perform continuous data collection that operates at regular intervals, gathering comprehensive information about device behaviors without impacting network performance or user experience. The framework can collect data points for each device every 15 minutes, accumulating up to one week of behavioral data to establish robust usage patterns and characteristics. This systematic data collection approach enables the framework to build detailed behavioral profiles that capture both short-term usage patterns and longer-term trends, providing the foundation for accurate device classification and user profiling.

In some embodiments, the framework can analyze device typing information that includes detailed hardware and category classifications, enabling the framework to understand the physical characteristics and intended usage patterns of different devices. The framework can process device type information such as iPhone, iPad, Android devices, and other specific hardware models, while also categorizing devices into broader functional categories including tablets, smartphones, gaming consoles, set-top boxes, laptops, smartwatches, televisions, and personal computers. This multi-level device classification enables the framework to apply appropriate analysis algorithms and behavioral expectations based on the specific characteristics and typical usage patterns of different device types.

In some embodiments, the framework can perform advanced application-time (“app-time”) analysis that captures detailed information related to, but not limited to, application usage, online behavior, network consumption patterns, and the like. The framework can analyze hourly or quarter-hourly aggregated data that includes application names, domain access patterns, online duration metrics, and network traffic volumes including both received and transmitted data. This comprehensive app-time analysis enables the framework to understand not only what applications and services are being accessed, but also how they are being used, the intensity of usage, and the patterns of engagement that characterize different user profiles.

In some embodiments, the framework can implement intelligent application categorization that enables semantic understanding of device usage patterns beyond simple application identification. The framework can classify applications and online activities into meaningful categories such as social media, news consumption, email communication, networking activities, streaming services, educational content, gaming, and productivity applications. This categorization capability enables the framework to analyze usage patterns at both the specific application level and the broader activity category level, providing more robust and meaningful insights into user behavior and device usage characteristics.

### Local Data Lake and Privacy-Preserving Storage

In some embodiments, the framework can implement a distributed local data lake architecture that enables on-device storage and retrieval of aggregated behavioral data while maintaining complete privacy protection and data sovereignty. The framework can maintain historical context and enable personalized pattern recognition without transmitting raw usage data to external servers or cloud services. This local data lake approach ensures that sensitive information about device usage, application preferences, and behavioral patterns remains entirely within the local network boundary while still enabling advanced analysis and machine learning capabilities.

In some embodiments, the framework can perform efficient data compression and storage optimization that enables the framework to maintain comprehensive behavioral histories within reasonable storage constraints. Based on the systematic data collection approach, the framework can store approximately 234 kilobytes of behavioral data per device per week, including timestamp information, device identifiers, application usage patterns, and network consumption metrics. This efficient storage approach enables the framework to maintain detailed behavioral histories for multiple devices over extended periods while minimizing storage requirements and enabling rapid data retrieval for analysis purposes.

In some embodiments, the framework can implement intelligent data retention policies that automatically manage the lifecycle of behavioral data, ensuring that relevant historical information is preserved while outdated or unnecessary data is systematically purged. The framework can maintain different retention periods for different types of data based on their relevance to ongoing classification tasks, with more recent data being preserved at higher resolution while older data may be aggregated or summarized to reduce storage requirements. This intelligent data management approach ensures that the framework maintains optimal performance while preserving the historical context necessary for accurate device classification.

In some embodiments, the framework can perform secure data isolation that ensures behavioral data for different devices and users remains completely separated and protected from unauthorized access. The framework can implement encryption, access controls, and data partitioning mechanisms that prevent cross-contamination of behavioral profiles while enabling efficient analysis of individual device patterns. This secure isolation approach ensures that the framework maintains privacy protection even within the local network environment while enabling the collaborative processing necessary for advanced device classification.

### Advanced Behavioral Pattern Recognition

In some embodiments, the framework can implement advanced pattern recognition capabilities that transform raw usage data into meaningful behavioral insights through advanced text processing and semantic analysis techniques. The framework can employ functionality that converts browser metadata, application usage traces, and network consumption patterns into coherent text-like structures that enable semantic interpretation and natural language processing. This transformation process enables the framework to convert quantitative usage data into qualitative behavioral narratives that capture usage intent, interaction patterns, and contextual characteristics.

In some embodiments, the framework can perform contextual behavior synthesis that creates comprehensive behavioral descriptions from fragmented usage data. For example, the framework can transform a series of URLs, online time measurements, and traffic patterns into descriptive narratives such as “On a summer Sunday from 7:00 to 8:00 AM, the user watched YouTube, checked email, and briefly browsed the New York Times.” This contextual synthesis capability enables the framework to understand not only what activities are occurring, but also the temporal, situational, and intentional context that characterizes different usage patterns and user profiles.

In some embodiments, the framework can implement advanced embedding generation that converts behavioral narratives into high-dimensional vector representations that capture semantic, behavioral, and contextual signals. The framework can utilize lightweight text embedding models such as, for example, all-MiniLM-L6-v2, which requires approximately 100 megabytes of storage and 22.7 million parameters to generate 384-dimensional embeddings. These embeddings enable the framework to perform advanced pattern matching and similarity analysis that can differentiate between adult and child-like browsing behaviors, usage patterns, and interaction characteristics.

In some embodiments, the framework can perform multi-dimensional behavioral analysis that considers not only individual application usage but also the relationships between different activities, the temporal patterns of usage, and the contextual factors that influence behavior. The framework can analyze sequences of activities, transitions between different types of content, usage intensity patterns, and the timing of different behaviors to create comprehensive behavioral profiles that capture the nuanced characteristics of different user types and age groups.

### Intelligent Classification and Decision Making

In some embodiments, the framework can implement advanced classification capabilities that utilize supervised machine learning models to assign probability scores to different age group classifications based on behavioral embeddings and usage patterns. The framework can deploy neural network classifiers, transformer models, or gradient-boosted tree algorithms that are optimized for high precision in child classification to support compliance and safety use cases. These classification models can require as little as 8 megabytes of storage and 2-3 million parameters while consuming only 25 megabytes of RAM during inference operations.

In some embodiments, the framework can perform adaptive threshold management that dynamically adjusts classification sensitivity based on confidence levels, historical accuracy, and contextual factors. The framework can implement intelligent threshold tuning that optimizes the balance between classification accuracy and false positive rates, ensuring that child devices are accurately identified while minimizing incorrect classifications that could impact user experience. This adaptive approach enables the framework to maintain high accuracy across different usage scenarios and device types while accommodating the natural variation in behavioral patterns.

In some embodiments, the framework can implement advanced cognitive mechanisms that serves as the autonomous reasoning and adaptive planning core of the classification system. Such mechanisms can operate at the intersection of historical memory, contextual understanding, and classifier insights to continuously synthesize input from real-time data, user behavior patterns, and embedding signals. The framework can generate explainable and context-aware decisions while dynamically tuning operational thresholds, mitigating false positives, and orchestrating intelligent actions ranging from user interface mode transitions to policy-based content filtering.

In some embodiments, the framework can perform continuous learning and adaptation that enables the classification system to evolve and improve over time based on user feedback, usage patterns, and environmental changes. The framework can implement feedback mechanisms that capture user corrections and preferences, enabling the system to refine its classification logic and adapt to changing behavioral patterns. This continuous learning approach ensures that the framework maintains accuracy and relevance as users evolve and as new usage patterns emerge within the network environment.

### Federated Learning and Model Optimization

In some embodiments, the framework can implement federated learning capabilities that enable continuous improvement of device classification accuracy through collaboration with cloud-based knowledge systems while maintaining complete privacy protection for local behavioral data. The framework can utilize pre-trained embedding models that can be fine-tuned using aggregated insights from multiple network deployments, enabling the system to benefit from collective learning while preserving individual privacy. This federated approach enables the framework to achieve higher accuracy and better generalization across different user populations and usage scenarios.

In some embodiments, the framework can perform intelligent model management that maintains both global and customized versions of classification models, enabling the system to benefit from broader knowledge while adapting to specific local characteristics. The framework can deploy a global classifier model that is trained on diverse behavioral data from multiple network deployments, while also maintaining locally customized versions that are gradually fine-tuned based on local usage patterns and user feedback. This dual-model approach enables the framework to achieve both broad applicability and personalized accuracy.

In some embodiments, the framework can implement efficient model updating mechanisms that enable the framework to incorporate new insights and improvements without requiring complete model retraining or significant computational overhead. The framework can utilize transfer learning techniques, incremental learning approaches, and model compression methods to enable efficient updates while maintaining classification accuracy. This efficient updating capability ensures that the framework can continuously improve while minimizing the computational and storage requirements associated with model maintenance.

In some embodiments, the framework can perform collaborative insight sharing where non-sensitive behavioral patterns, classification techniques, and optimization strategies can be shared across multiple network deployments to improve overall system performance. The framework can participate in federated learning networks where aggregated insights about behavioral patterns, classification accuracy, and model performance can be shared without revealing specific information about individual users or devices. This collaborative approach enables continuous improvement of framework capabilities while preserving privacy and security.

### Operational Modes and Adaptive Processing

In some embodiments, the framework can implement multiple operational modes that enable the system to adapt its processing approach based on device characteristics, usage patterns, and computational requirements. The framework can operate in a Regular Mode designed for new devices that prioritizes accuracy over computational efficiency, performing continuous monitoring and weekly updates that commence one week after initial device connection. This mode enables the framework to build comprehensive behavioral profiles for new devices while ensuring accurate classification through intensive analysis and pattern recognition.

In some embodiments, the framework can implement a Monitoring Mode specifically designed for shared devices that need to distinguish between different users accessing the same device. This mode can operate with optimized processing schedules, running classification analysis every 15 minutes while maintaining speed and efficiency through reduced model complexity or precision adjustments. This monitoring approach enables the framework to provide real-time user identification for shared devices while minimizing computational overhead and maintaining responsive performance.

In some embodiments, the framework can perform traffic and network data similarity analysis that categorizes devices based on similarity scores and groups them by likely ownership patterns. The framework can analyze network consumption patterns, application usage similarities, and behavioral correlations to identify devices that likely belong to the same user or family member. This similarity analysis enables the framework to improve classification accuracy by leveraging behavioral patterns across multiple devices while also enabling more efficient resource allocation and processing optimization.

In some embodiments, the framework can implement adaptive processing strategies that automatically adjust computational intensity, analysis frequency, and model complexity based on available resources, device characteristics, and accuracy requirements. The framework can detect when network resources are being heavily utilized and automatically scale back classification processing to maintain network performance, while increasing analysis intensity when additional computational resources become available. This adaptive approach ensures that device classification capabilities remain effective regardless of varying network conditions and computational constraints.

### User Feedback Integration and Continuous Improvement

In some embodiments, the framework can implement comprehensive user feedback mechanisms that enable continuous refinement of classification accuracy and system behavior based on user corrections, preferences, and satisfaction metrics. The framework can integrate with user interface applications to capture feedback about classification accuracy, enabling users to correct misclassifications and provide additional context about device usage patterns. This feedback integration ensures that the framework continuously improves its accuracy while adapting to the specific characteristics and preferences of individual network environments.

In some embodiments, the framework can perform intelligent feedback processing that analyzes user corrections and preferences to identify systematic classification errors and optimization opportunities. The framework can track patterns in user feedback to identify common misclassification scenarios, environmental factors that impact accuracy, and user preferences that should be incorporated into the classification process. This intelligent feedback analysis enables the framework to make systematic improvements rather than simply correcting individual errors.

In some embodiments, the framework can implement explainable decision making that provides users with clear insights into why specific classification decisions were made and what factors influenced the analysis. The framework can generate human-readable explanations that describe the behavioral patterns, usage characteristics, and contextual factors that contributed to specific classifications. This explainability capability enables users to understand system behavior, provide more effective feedback, and make informed decisions about classification accuracy and system configuration.

In some embodiments, the framework can perform privacy-preserving feedback aggregation that enables the system to benefit from user feedback while maintaining complete privacy protection for individual behavioral data. The framework can aggregate feedback patterns and classification improvements across multiple devices and users while ensuring that specific behavioral information remains protected. This privacy-preserving aggregation approach enables the framework to achieve collective learning benefits while maintaining the privacy and security advantages of local processing.

### Sensor Networks

In some embodiments, the framework can implement comprehensive sensor network capabilities that transform traditional home and office environments into intelligent, responsive ecosystems through the deployment of distributed wireless sensor arrays. The framework can leverage the existing network infrastructure to create an advanced sensor management system that operates entirely within the local network boundary, eliminating the need for external cloud dependencies while providing enhanced privacy, reduced latency, and elimination of ongoing subscription costs. This approach represents a fundamental shift from cloud-dependent sensor systems to locally processed, battery-powered sensor networks that can operate autonomously while contributing to the broader intelligent environment within the location.

In some embodiments, the framework can establish what may be termed “elastic edge sensor processing,” where sensor data analysis and decision-making workloads are dynamically distributed across available network devices based on their computational capacity, power availability, and proximity to sensor clusters. The framework can orchestrate these resources through an advanced coordination mechanism that treats each participating device as a specialized processing node in a local compute cluster, effectively creating a miniaturized cloud environment optimized for sensor data processing and real-time response generation. This distributed approach enables the framework to scale processing power incrementally as new sensors join the network while maintaining fault tolerance through distributed redundancy.

In some embodiments, the framework can implement a multi-tiered sensor processing hierarchy where different aspects of sensor data analysis are assigned to network components based on their computational strengths, power characteristics, and data access capabilities. For example, the framework can assign initial data collection and aggregation tasks to Wi-Fi access points and mesh nodes that have direct wireless connectivity to sensor arrays, while more computationally intensive tasks such as pattern recognition, predictive analysis, and automated response generation can be distributed to more powerful AC-powered devices within the network. This hierarchical approach enables the framework to optimize both power consumption and processing efficiency while maintaining the real-time responsiveness required for effective sensor network management.

### Wireless Sensor Integration and Power Management

In some embodiments, the framework can perform advanced wireless sensor integration that accommodates diverse sensor types including window and door sensors for security monitoring, temperature sensors distributed throughout the environment for climate control optimization, light sensors for automated lighting and shade adjustment, and various camera systems for doorbell and security applications. The framework can manage these diverse sensor types through unified protocols and communication standards, enabling seamless integration regardless of sensor manufacturer, communication protocol, or specific functionality requirements.

In some embodiments, the framework can implement intelligent power management strategies that optimize battery life for wireless sensors by leveraging the principle that wireless transmission energy requirements have evolved to approximate the energy required for local memory operations, with both requiring approximately 100 nanojoules per bit of information processed. This energy equivalence enables the framework to make intelligent decisions about when to process data locally within the sensor versus when to transmit data to AC-powered devices within the network for more intensive processing, optimizing overall system power consumption while maintaining functionality.

In some embodiments, the framework can perform adaptive transmission scheduling that minimizes power consumption by optimizing the timing, frequency, and data volume of sensor communications based on sensor type, data criticality, and current network conditions. The framework can implement intelligent buffering strategies that aggregate sensor data locally when possible, transmit data during optimal network conditions, and prioritize critical sensor information while deferring less time-sensitive data to periods of lower network activity. This adaptive approach enables the framework to maximize battery life while ensuring that critical sensor information is transmitted and processed in a timely manner.

In some embodiments, the framework can implement energy harvesting optimization that enables sensors to supplement battery power through environmental energy sources such as solar panels, vibration harvesting, or thermal gradient exploitation. The framework can monitor energy availability from these sources and dynamically adjust sensor operation modes, transmission schedules, and processing intensity based on available energy resources. This energy harvesting integration enables the framework to extend sensor operation periods while reducing battery replacement requirements and maintenance overhead.

### Local Data Processing and Privacy Protection

In some embodiments, the framework can perform comprehensive local data processing that eliminates the need to transmit sensitive sensor data to external cloud services, thereby maintaining complete privacy protection while reducing ongoing operational costs. The framework can process sensor data entirely within the local network environment, enabling more extensive and continuous analysis since computational costs are not constrained by external service pricing models or data transmission limitations. This local processing approach enables the framework to provide advanced sensor analysis capabilities while maintaining complete data sovereignty and privacy protection.

In some embodiments, the framework can implement intelligent data aggregation that combines information from multiple sensors to provide comprehensive environmental understanding and automated response capabilities. The framework can correlate data from temperature sensors, occupancy detectors, light sensors, and security devices to create holistic environmental profiles that enable more effective automated responses than would be possible through individual sensor analysis. This aggregated approach enables the framework to understand complex environmental relationships and provide more intelligent automated responses to changing conditions.

In some embodiments, the framework can perform real-time pattern recognition that identifies trends, anomalies, and predictive indicators within sensor data streams without requiring external processing or analysis services. The framework can analyze historical sensor data to establish baseline patterns, identify unusual conditions that may require attention, and predict future environmental changes that may benefit from proactive responses. This local pattern recognition capability enables the framework to provide proactive environmental management while maintaining complete privacy protection for sensitive sensor information.

In some embodiments, the framework can implement contextual sensor fusion that combines data from multiple sensor types to provide enhanced understanding of environmental conditions and user activities. The framework can correlate motion detection with temperature changes, lighting conditions with occupancy patterns, and security sensor status with normal activity patterns to provide more accurate and meaningful environmental analysis. This sensor fusion capability enables the framework to reduce false alarms, improve automated response accuracy, and provide more comprehensive environmental monitoring than would be possible through individual sensor analysis.

### Automated Response and Environmental Control

In some embodiments, the framework can implement advanced automated response capabilities that can trigger appropriate environmental adjustments based on sensor data analysis and user preferences. The framework can integrate with heating and air conditioning systems to optimize temperature control based on occupancy patterns and environmental conditions, adjust lighting systems based on natural light availability and user activity, and manage security systems based on occupancy detection and access patterns. This automated response capability enables the framework to provide proactive environmental management while reducing energy consumption and improving user comfort.

In some embodiments, the framework can perform predictive environmental control that anticipates environmental changes and adjusts systems proactively rather than reactively. The framework can analyze historical sensor data, weather patterns, and user behavior to predict heating and cooling needs, lighting requirements, and security considerations before they become apparent to users. This predictive capability enables the framework to provide more comfortable and efficient environmental control while reducing energy consumption and system wear.

In some embodiments, the framework can implement intelligent scheduling that coordinates automated responses across multiple systems to optimize overall environmental performance and energy efficiency. The framework can schedule heating and cooling adjustments to coincide with occupancy patterns, coordinate lighting controls with natural light availability, and manage security system responses based on expected activity patterns. This coordinated scheduling approach enables the framework to provide comprehensive environmental management while minimizing energy consumption and system conflicts.

In some embodiments, the framework can perform adaptive learning that continuously improves automated response accuracy based on user feedback, environmental outcomes, and system performance metrics. The framework can learn from user adjustments to automated responses, track the effectiveness of different environmental control strategies, and adapt its decision-making processes to better align with user preferences and environmental requirements. This adaptive learning capability enables the framework to provide increasingly personalized and effective environmental management over time.

### Cost-Effective Deployment and Maintenance

In some embodiments, the framework can provide cost-effective sensor network deployment that eliminates the need for ongoing subscription fees or cloud service charges that can make sensor systems financially impractical for many users. The framework can operate entirely on existing network infrastructure without requiring additional cloud services, external processing fees, or ongoing operational costs beyond the initial hardware investment. This cost-effective approach enables widespread deployment of comprehensive sensor networks without the financial barriers associated with cloud-dependent systems.

In some embodiments, the framework can implement scalable sensor integration that enables users to gradually expand their sensor networks based on their needs and budget constraints without requiring system redesign or infrastructure changes. The framework can automatically detect and integrate new sensors as they are added to the network, configure appropriate processing and response protocols, and incorporate new sensor data into existing environmental analysis and control systems. This scalable approach enables users to build comprehensive sensor networks incrementally while maintaining system functionality and performance.

In some embodiments, the framework can perform intelligent maintenance scheduling that monitors sensor performance, battery levels, and communication quality to provide proactive maintenance alerts and optimization recommendations. The framework can track sensor battery life, communication reliability, and data quality to predict when maintenance may be required and provide specific recommendations for system optimization. This intelligent maintenance capability enables the framework to maintain optimal sensor network performance while minimizing maintenance overhead and system downtime.

In some embodiments, the framework can implement self-healing network capabilities that automatically detect and compensate for sensor failures, communication disruptions, or network issues without requiring manual intervention. The framework can reroute sensor communications through alternative network paths, adjust processing algorithms to accommodate missing sensor data, and provide alternative sensor coverage when individual sensors become unavailable. This self-healing capability ensures that sensor networks remain functional and effective even when individual components experience problems.

### Advanced Analytics and Optimization

In some embodiments, the framework can perform comprehensive sensor analytics that provide users with detailed insights into environmental patterns, energy usage, security events, and system performance without requiring external analytics services or data transmission. The framework can generate reports about temperature patterns, occupancy trends, energy consumption, security incidents, and environmental optimization opportunities based entirely on local sensor data analysis. This local analytics capability enables users to understand their environmental patterns while maintaining complete privacy protection.

In some embodiments, the framework can implement machine learning capabilities that enable continuous improvement of sensor network performance through pattern recognition, predictive modeling, and optimization algorithms that operate entirely within the local network environment. The framework can learn from historical sensor data to improve predictive accuracy, optimize automated response strategies, and identify opportunities for energy savings and performance improvements. This local machine learning capability enables the framework to provide increasingly advanced environmental management without requiring external processing resources.

In some embodiments, the framework can perform cross-sensor correlation analysis that identifies relationships between different sensor types and environmental conditions to provide more comprehensive understanding of environmental dynamics. The framework can analyze relationships between temperature sensors and occupancy patterns, correlate lighting sensor data with energy consumption, and identify connections between security sensor activity and normal environmental patterns. This correlation analysis enables the framework to provide more accurate and meaningful environmental insights while improving automated response effectiveness.

In some embodiments, the framework can implement optimization algorithms that continuously adjust sensor network operation, processing strategies, and automated response protocols to maximize performance, minimize energy consumption, and improve user satisfaction. The framework can optimize sensor sampling rates, adjust communication schedules, refine automated response thresholds, and balance system performance against energy consumption based on actual usage patterns and environmental conditions. This continuous optimization capability ensures that sensor networks operate at peak efficiency while adapting to changing environmental conditions and user requirements.

### Parental Controls

In some embodiments, the framework can implement advanced parental control mechanisms that operate directly within the home network infrastructure, leveraging the distributed AI capabilities to provide real-time content filtering and device management without relying on cloud-based processing or requiring software installation on individual devices. This approach represents a significant advancement over traditional parental control solutions that typically require manual configuration of block lists, per-device software installation, or cloud-dependent filtering services that introduce latency and privacy concerns.

In some embodiments, the framework can utilize its AI-powered device classification capabilities to automatically identify and categorize devices based on their network traffic patterns and usage behaviors. Rather than requiring parents to manually configure which devices belong to which family members, the framework employs machine learning algorithms that analyze network communication patterns to determine both the type of device and the likely age demographics of its users. This classification process operates continuously in the background, observing the transmitted and received network traffic to build profiles that distinguish between adult-oriented devices such as work laptops or streaming devices, and child-oriented devices like gaming consoles, tablets, or smartphones used primarily for entertainment and social media consumption.

In some embodiments, the framework can achieve remarkably high accuracy in device classification through its federated learning approach. Such accuracy, for example, can be realized via the framework′ functionality for learning from local patterns while benefiting from aggregated insights across multiple homes, creating a robust classification model that adapts to the specific usage patterns within each household while maintaining privacy by keeping sensitive browsing history and personal data local to each home.

In some embodiments, the framework can implement dynamic content filtering that operates transparently at the network level, intercepting and analyzing web traffic in real-time to identify potentially inappropriate content before it reaches child devices. The AI model processes incoming data streams to evaluate content against age-appropriate guidelines, automatically blocking access to websites, applications, or services that contain mature content, violence, or other material deemed unsuitable for younger users. This filtering operates seamlessly without requiring browser extensions, parental control software on individual devices, or modifications to existing applications, making it particularly effective for IoT devices, gaming consoles, and other connected devices where traditional parental control software cannot be installed.

In some embodiments, the framework can implement time-based access controls that automatically adjust filtering rules and network access permissions based on daily schedules and household routines. The framework can learn family patterns and automatically enforce stricter content filtering during homework hours, implement complete internet restrictions during designated family time or meal periods, and gradually reduce access to entertainment services as bedtime approaches. These temporal controls can be customized for different age groups within the household, allowing older children to have extended access while implementing earlier cutoff times for younger family members.

In some embodiments, the framework can provide adaptive learning capabilities that continuously refine parental control effectiveness based on family interactions and override decisions. When parents choose to whitelist previously blocked content or modify access permissions, the AI framework learns from these decisions and adjusts its filtering algorithms accordingly. This creates a self-improving framework that becomes more accurately tuned to each family's specific values and preferences over time, reducing false positives and ensuring that legitimate educational or entertainment content is not unnecessarily restricted while maintaining protection against genuinely inappropriate material.

In some embodiments, the framework can leverage its distributed computing architecture to implement parental controls without introducing significant network latency or performance degradation. By processing content filtering decisions locally on network infrastructure devices such as access points, routers, and mesh network nodes, the framework can make instantaneous blocking decisions without the delays associated with cloud-based filtering services. This local processing approach also ensures that parental controls remain functional even during internet outages or when cloud services are unavailable, providing consistent protection regardless of external connectivity conditions.

In some embodiments, the framework can integrate occupancy monitoring capabilities with parental control functions to provide context-aware content filtering that adapts based on who is present in the home. Using WiFi signal analysis and network traffic patterns, the framework can detect when parents are present versus when children are home alone, automatically adjusting content filtering strictness accordingly. This capability enables more permissive access when parents are available to supervise internet usage while implementing stricter controls during unsupervised periods, creating a dynamic protection framework that adapts to real-world family situations.

In some embodiments, the framework can provide detailed reporting and analytics capabilities that give parents insight into their children's internet usage patterns without compromising privacy. The framework can generate reports showing time spent on different categories of websites, attempted access to blocked content, and overall device usage patterns, while keeping detailed browsing history and personal information local to the home network. This reporting functionality helps parents understand their children's digital habits and make informed decisions about adjusting parental control settings or having conversations about appropriate internet usage.

In some embodiments, the framework can implement graduated response mechanisms that provide educational opportunities rather than simply blocking access to questionable content. When potentially inappropriate content is detected, the framework can present age-appropriate explanations about why the content was blocked, suggest alternative educational resources, or prompt children to discuss the content with parents before proceeding. This approach transforms parental controls from purely restrictive measures into educational tools that help children develop critical thinking skills about online content and digital citizenship.

In some embodiments, the framework can maintain these comprehensive parental control capabilities while preserving family privacy through its federated learning architecture, ensuring that sensitive information about children's internet usage, family schedules, and household patterns remains securely within the home network while still benefiting from improvements and updates developed through the collective learning of the broader system deployment.

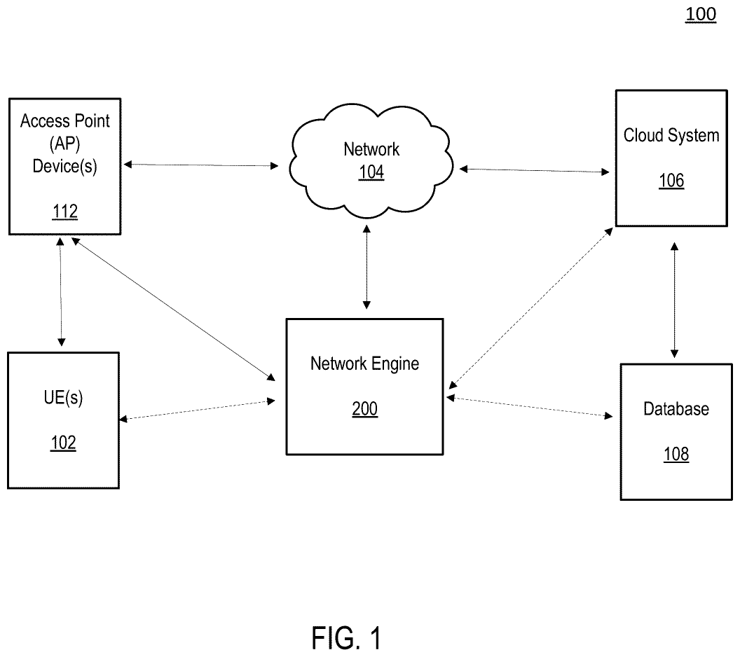

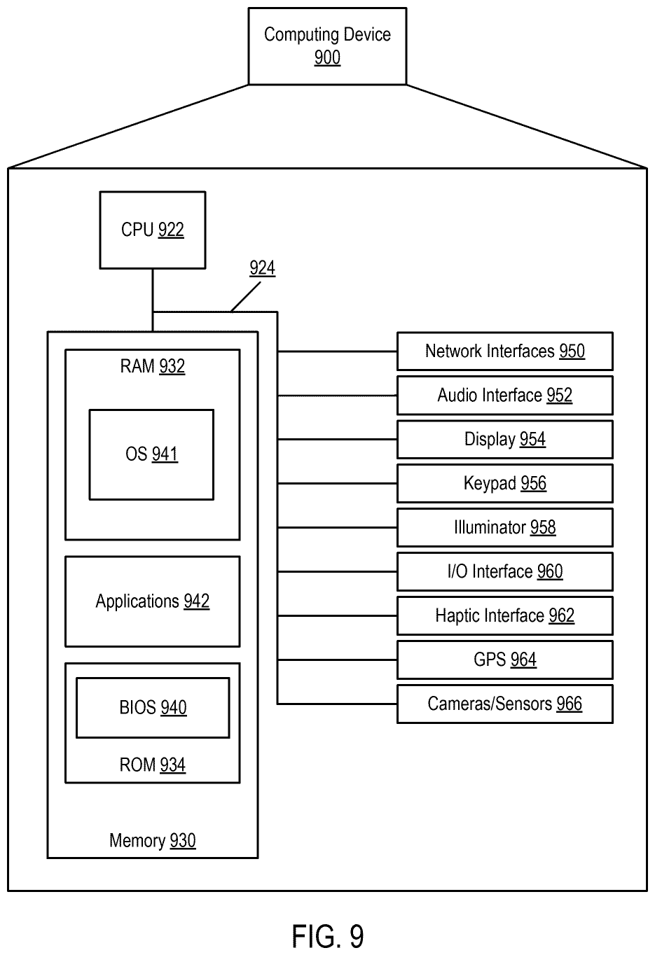

With reference to FIG. 1, system 100 is depicted which includes user equipment (UE) 102 (e.g., a client device, as mentioned above and discussed below in relation to FIG. 9), access point (AP) device 112, network 104, cloud system 106, database 108 and network engine 200. It should be understood that while system 100 is depicted as including such components, it should not be construed as limiting, as one of ordinary skill in the art would readily understand that varying numbers of UEs, AP devices, peripheral devices, sensors, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, IoT device, camera, wearable device, autonomous machine, smart television, set top box (STB), media streaming device, game console, and any other device equipped with a cellular or wireless or wired transceiver. For example, UE 102 can be a smart phone of a user.

In some embodiments, peripheral devices (not shown) can be connected to UE 102, and can be any type of peripheral device, such as, but not limited to, a wearable device (e.g., smart ring, smart watch, for example), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

In some embodiments, UE 102 can include and/or correspond to, but not be limited to, any type of device, component and/or sensor associated with a location of system 100 (referred to, collectively, as “sensors”). In some embodiments, the UE 102 can be any type of device that is capable of sensing and capturing data/metadata related to activity of the location. In some embodiments, the sensors can be associated with devices associated with the location of system 100, such as, for example, STBs, cameras, access point devices, televisions, personal assistants (e.g., Alexa®, Nest®, for example)), smart phones, smart watches or other wearables, tablets, personal computers, and the like, and some combination thereof. In some embodiments, UE 102 can be associated with any device connected and/or operating on cloud system 106 (e.g., a cloud-based device, such as a server that collects information related to the location, for example).

According to some embodiments, AP device 112 is a device that creates and/or provides a wireless local area network (WLAN) for the location. According to some embodiments, the AP device 112 can be, but is not limited to, a router, switch, hub, gateway, extender and/or any other type of network hardware that can project a WiFi signal to a designated area. In some embodiments, UE 102 may be an AP device.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a service provider, content provider, internet service provider ISP), communication service provider (CSP), and the like, which has associated network resources hosted on the internet or private network (e.g., network 104), which enables (via engine 200) the content management and delivery discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, AP device 112, and the services and applications provided by cloud system 106 and/or network engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

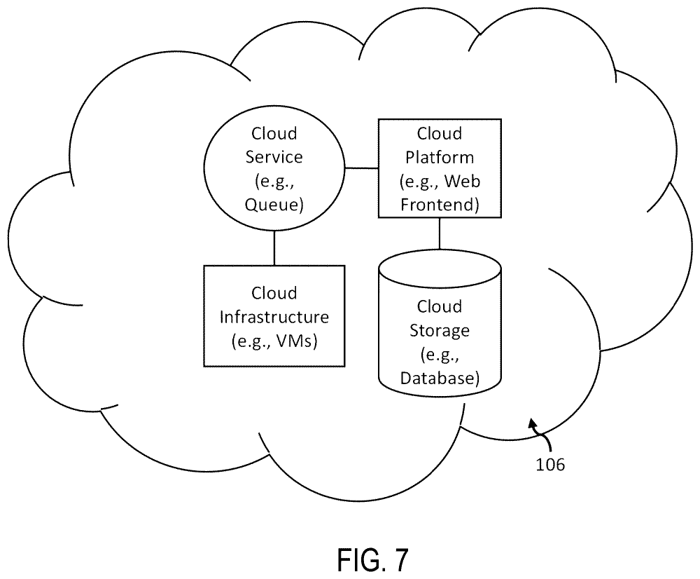

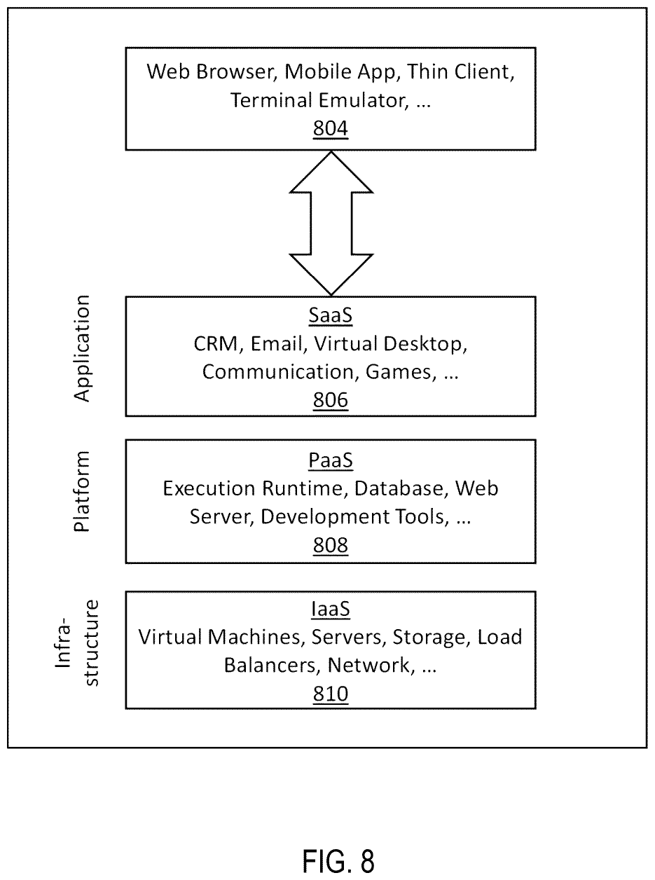

Turning to FIGS. 7 and 8, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 810, platform as a service (PaaS) 808, and/or software as a service (SaaS) 806 using a web browser, mobile app, thin client, terminal emulator or other endpoint 804. FIGS. 7 and 8 illustrate schematics of non-limiting embodiments of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, structured query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Network engine 200, as discussed above and further below in more detail, can include components for the disclosed functionality. According to some embodiments, network engine 200 may be a special purpose machine or processor, and can be hosted by a device on network 104, within cloud system 106, on AP device 112 and/or on UE 102. In some embodiments, engine 200 may be hosted by a server and/or set of servers associated with cloud system 106.

According to some embodiments, network engine 200 or other device(s) running Processes 300-600, discussed infra, can be operated entirely at the user device level (or local or local network (e.g., WiFi) level), and/or in some embodiments, with cloud support as a distributed system, or at a service provider's infrastructure, as non-limiting implementation examples. It will be understood that the disclosure herein provides for a configuration that is platform agnostic and can be operated on multiple alternative platforms as a matter of design choice using the teachings described.

According to some embodiments, as discussed in more detail below, network engine 200 may be configured to implement and/or control a plurality of services and/or microservices, where each of the plurality of services/microservices are configured to execute a plurality of workflows associated with performing the disclosed network management. Non-limiting embodiments of such workflows are discussed and provided below.

According to some embodiments, as discussed above, network engine 200 may function as an application provided by a content and/or service provider and/or cloud system 106. In some embodiments, engine 200 may function as an application installed on a server(s), network location and/or other type of network resource associated with system 106. In some embodiments, engine 200 may function as an application installed and/or executing on AP device 112 and/or UE 102. In some embodiments, such application may be a web-based application accessed by AP device 112 and/or UE 102, and/or devices accessible over network 104 from cloud system 106. In some embodiments, engine 200 may be configured and/or installed as an augmenting script, program or application (e.g., a plug-in or extension) to another application or program provided by cloud system 106 and/or executing on AP device 112 and/or UE 102. Accordingly, as provided below, engine 200 can execute on a device, at a network location, on nodes of a network and/or across a network, on differing components to perform the operations of each module executing therein.

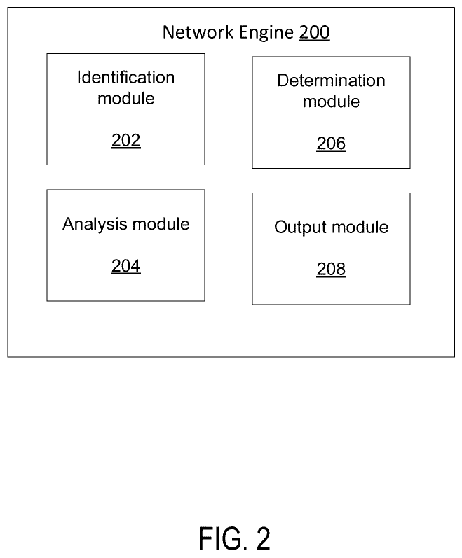

As illustrated in FIG. 2, according to some embodiments, network engine 200 includes identification module 202, analysis module 204, determination module 206 and output module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

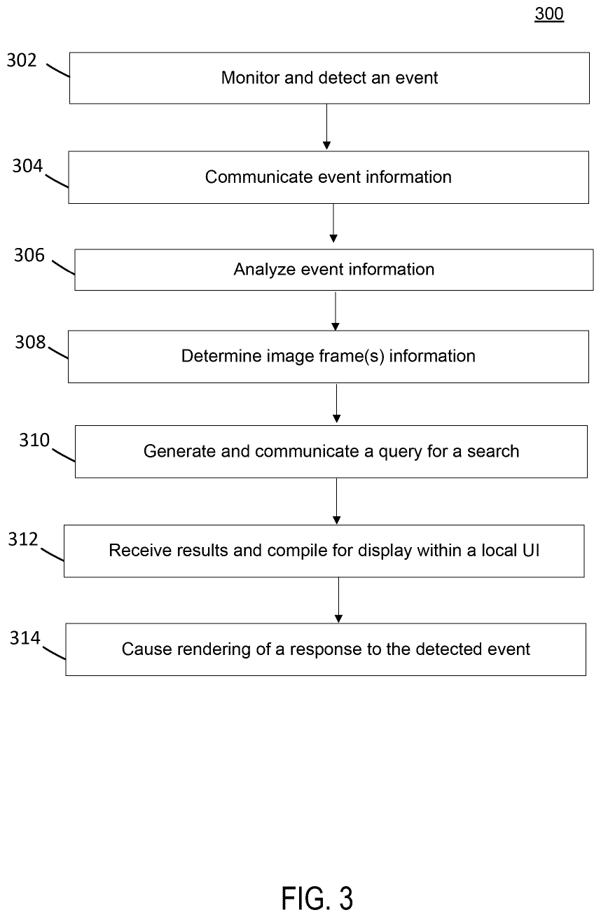

Turning to FIG. 3, Process 300 provides non-limiting example embodiments for the disclosed network management. As discussed herein, Process 300 provides operational steps for a real-time image processing workflow operating within the confines of a local network. Such process enables low-latency, and contextually rich processing of video content without reliance on external cloud services.

According to some embodiments, Steps 302 and 304 of Process 300 can be performed by identification module 202 of network engine 200; Step 306 can be performed by analysis module 204; Step 308 can be performed by determination module 206; and Steps 310-314 can be performed by output module 208.

According to some embodiments, Process 300 begins with Step 302 where engine 200 can continuously (or periodically, according to a criterial (e.g., request, time, date, detected data type, for example)) monitor for predefined triggering events within the localized environment (e.g., input to a set top box indicating to capture an image frame or frames). This monitoring can occur across a variety of connected devices, including but not limited to smart televisions, set-top boxes, mesh Wi-Fi routers, smart home hubs, security cameras, and IoT sensors. Engine 200 deploys lightweight, continuously running event detection modules on these devices to capture key video interaction triggers. For example, in the context of video playback, the event trigger may be a user pausing a video, requesting additional information, or requesting operation of capturing a frame.

In some embodiments, in surveillance environments, for example, the event could be defined by motion detection algorithms, anomaly detection routines, or external stimuli such as doorbell rings or environmental sensor activations.

Engine 200 operates a distributed monitoring protocol whereby each device reports candidate events to a central coordination node, also part of engine 200, which filters, prioritizes, and selects relevant events for subsequent processing. This ensures minimal system resource consumption during idle periods while maintaining high responsiveness to user or environmental triggers.

In Step 304, once an event is detected and validated, engine 200 initiates the collection and aggregation of event-specific data. This includes capturing the associated video frame(s), extracting image data in high-resolution format where possible, and collating relevant metadata such as frame timestamps, source device identifiers, initial motion vectors, lighting conditions, and other environmental context markers. This data aggregation step may also incorporate a buffer of adjacent frames—both preceding and following the event—to provide temporal context for downstream analysis. The collected image and metadata package is then communicated within the local network to an embedded agentic AI module, which may consist of one or more large language models (LLMs), computer vision models, or specialized domain-specific AI modules, all deployed in a decentralized manner across the available local devices.

According to some embodiments, engine 200 manages this communication using high-throughput, low-latency internal networking protocols, leveraging the local Wi-Fi or mesh infrastructure to maintain efficient data flow while preserving strict data locality.

In Step 306, engine 200 coordinates the execution of advanced analytical processing on the event-triggered image data using both AI/ML models and LLM-based semantic reasoning systems deployed locally.

In some embodiments, engine 200 can first perform a pre-processing pipeline designed to enhance the raw captured frame. This may include image quality optimizations such as noise reduction using convolutional neural networks (CNN)-based denoisers, dynamic range adjustments to correct for overexposure or underexposure, sharpening filters to enhance edge clarity, and motion deblurring algorithms particularly useful for frames captured during high-motion scenes. Furthermore, engine 200 can apply automatic color correction and gamma adjustments to standardize the image for downstream recognition tasks.

Following pre-processing, engine 200 activates computer vision inference models—such as locally hosted YOLO (You Only Look Once), MobileNet, or EfficientDet instances—to perform object detection, facial detection, and region-of-interest segmentation within the frame. The framework is designed to operate in a multi-modal fashion, where these initial detection results are augmented by LLM-based reasoning pipelines. For example, the LLM component, operating entirely within the local cluster, interprets the detected entities in relation to one another, applying context-based reasoning to determine probable scene compositions, interpersonal relationships, or object functions. The LLM may additionally parse and interpret any text detected within the frame using optical character recognition (OCR) pipelines, enabling semantic understanding of embedded information such as product labels, signage, or subtitles.

In some embodiments, as discussed herein, such analysis can involve engine 200 implementing any type of known or to be known computational analysis technique, algorithm, mechanism or technology. In some embodiments, engine 200 may include a specific trained AI/ML model, a particular machine learning model architecture, a particular machine learning model type (e.g., CNN, recurrent neural network (RNN), autoencoder, support vector machine (SVM), and the like), or any other suitable definition of a machine learning model or any suitable combination thereof.

In some embodiments, engine 200 may leverage an LLM(s), whether known or to be known. As discussed herein, an LLM is a type of AI system designed to understand and generate human-like text based on the input it receives. The LLM can implement technology that involves deep learning, training data and natural language processing (NLP). Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. Such includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the data, as discussed herein.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In Step 308, engine 200 performs entity classification and scene comprehension. Leveraging the output of the computer vision detection mechanisms, engine 200 utilizes its LLM capabilities to synthesize a structured understanding of the scene. For example, a detected human figure may be further analyzed to determine approximate demographic characteristics (e.g., adult, child, profession indicators), emotional expressions, or unique clothing features. Detected objects can be categorized by product type, brand likeness, or functional class. Locations within the frame may be analyzed for architectural features, environmental cues, or recognizable landmark patterns.

According to some embodiments, such process incorporates probabilistic confidence scoring, where engine 200 maintains a confidence index for each entity classification and adjusts its downstream processing pathways based on these scores. Low-confidence detections may trigger fallback analysis using alternative models or flag the frame for deferred background processing during low-resource windows.

In Step 310, based on the completed entity recognition and contextual scene understanding, engine 200 constructs a structured, privacy-compliant query to external databases or knowledge bases. Rather than transmitting raw images or sensitive identifiable information, engine 200 can synthesize/generate a semantic query representation, converting localized detections into abstracted query statements. For example, the system may generate queries such as, “Identify red electronic devices resembling a countertop blender,” or “Retrieve historical significance of architectural structures with domed roofs and stone columns.” The query generation process is facilitated by the LLM's natural language generation (NLG) capabilities, allowing for rich, context-aware query formation.

In Step 312, engine 200 manages the receipt of response data from external services or knowledge bases. This may involve asynchronous network requests via privacy-respecting APIs to general knowledge services (e.g., Wikipedia summaries), product databases, or specialized reference sources (e.g., art databases, historical registries). Upon receiving query results, engine 200 performs a local post-processing routine to integrate, filter, and rank the results according to relevance, user context, and confidence thresholds established during initial frame analysis. Such result synthesis pipeline may involve deduplication of overlapping responses, elimination of low-confidence matches, and application of user-specific preferences (e.g., preferred content languages, categories of interest). Additionally, engine 200 may implement intelligent pre-fetching of related data and caching of frequently accessed information to improve subsequent response times and reduce redundant external queries.

In Step 314, engine 200 renders the compiled response data within a user-facing local interface. Depending on the operational context, this rendering may take the form of a minimal overlay on a television or video playback device, an interactive popup on a smart home hub display, or a mobile device notification containing contextually relevant supplementary information. The rendered response is designed to be unobtrusive yet accessible, enabling users to quickly assimilate additional information regarding the captured scene without disrupting their primary interaction flow.

In some embodiments, engine 200 can operate dynamic interface modalities, including voice interaction for environments equipped with smart speakers, touch interaction for devices with displays, and contextual triggers for smart environments (e.g., activating lighting scenes upon detecting certain visual cues).

Throughout Steps 302 to 314, engine 200 dynamically manages computational resource allocation across the localized network infrastructure. Engine 200 can utilize elastic load balancing principles to distribute processing workloads among devices based on real-time performance metrics such as CPU utilization, thermal load, and available memory. Engine 200 can operate under a fault-tolerant framework where partial analysis tasks are redundantly distributed across multiple nodes, ensuring system resilience in the event of individual device failures or network interruptions. The framework employs real-time performance monitoring to adaptively scale the depth and complexity of analysis—performing lightweight quick assessments during high network activity periods and engaging more sophisticated multi-pass analytical routines when ample resources are available.

Furthermore, engine 200 incorporates advanced privacy management protocols at every stage of Process 300. All raw image data remains confined within the network perimeter, with explicit safeguards preventing data exfiltration beyond localized devices. Users can configure fine-grained privacy preferences dictating which types of external queries are permissible, the granularity of entity recognition performed, and whether predictive pre-analysis is enabled. Engine 200 supports secure audit logs of processing events, enabling transparency into when and how external communications occur and providing users with confidence in the privacy integrity of the system.

Collectively, Process 300 exemplifies a fully localized, intelligent, and privacy-centric video content analysis workflow that maximizes responsiveness and user value without compromising personal data security. Engine 200's advanced orchestration of distributed AI/ML and LLM capabilities within a local edge computing framework ensures that even computationally intensive tasks, such as high-fidelity image understanding and contextual scene reasoning, can be executed in real time, directly at the point of data generation.

Accordingly, the processing in Process 300's steps provides functionality that fundamentally transforms traditional video content analysis by eliminating cloud dependency, reducing latency, and preserving data privacy while maintaining the flexibility to tap into external knowledge sources in a controlled, abstracted manner. Through the meticulous execution of Steps 302 through 314, engine 200 provides a scalable, extensible, and user-adaptive solution that aligns with modern privacy expectations and the growing demand for real-time, intelligent video interaction capabilities within home, office, and commercial environments.

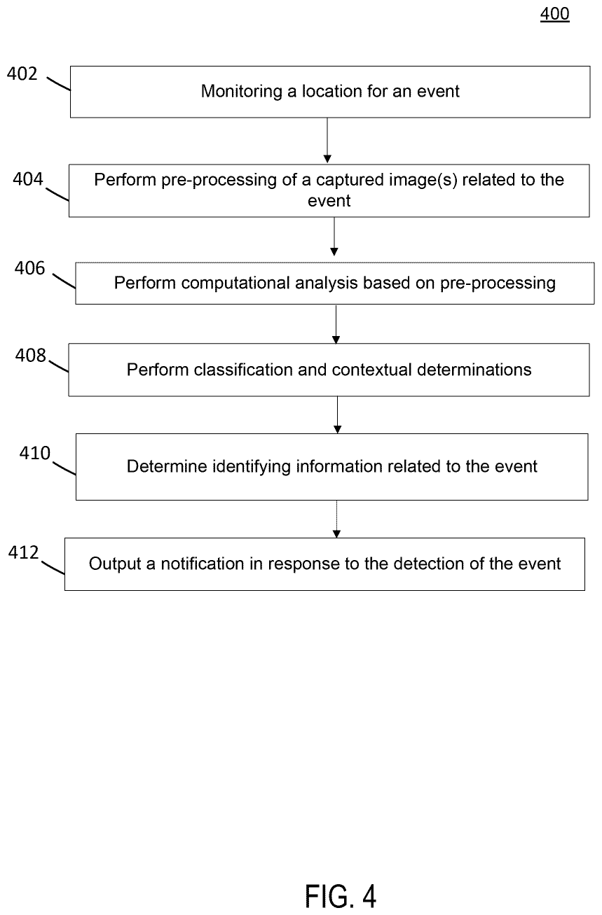

Turning to FIG. 4, Process 400 provides non-limiting example embodiments for operational steps for a real-time image processing workflow for scene detection, person identification and security monitoring functions across connected devices (e.g., cameras, for example) in a local network environment.

According to some embodiments, Step 402 of Process 400 can be performed by identification module 202 of network engine 200; Steps 404 and 406 can be performed by analysis module 204; Steps 408 and 410 can be performed by determination module 206; and Step 412 can be performed by output module 208.

According to some embodiments, Process 400 begins with Step 402 where engine 200 can function to actively manage a distributed sensor network by continuously (or periodically, as discussed above) monitoring multiple image capture devices across the local environment for incoming visual data streams. Step 402 can involve establishing persistent connections with security cameras, smart doorbells, video-enabled access control systems, and other connected imaging devices. Engine 200 implements lightweight polling or event-driven triggers to receive streaming video feeds or periodic frame captures, depending on system configuration. Each device operates as a local acquisition node, transmitting image frames in near real-time to designated processing nodes within the local compute cluster. To minimize bandwidth overhead and maintain network stability, engine 200 utilizes efficient intra-network transmission protocols, such as UDP-based multicast or optimized TCP streams, alongside adaptive bitrate mechanisms to regulate image data flow based on current network conditions.

In Step 404, engine 200 performs initial image pre-processing functions by assigning basic image normalization tasks to the devices closest to the data source—often the imaging devices themselves or adjacent low-compute nodes such as mesh access points. This pre-processing pipeline includes frame resizing, luminance normalization, contrast enhancement, and basic deblurring operations to optimize the image quality for subsequent AI analysis. Engine 200 can dynamically determine the appropriate level of pre-processing based on the computational profile of each node, ensuring that minimal computational effort is expended on nodes with limited capacity while preserving high image fidelity for downstream inference. This approach reduces noise and standardizes input frames, creating uniformity across data streams from heterogeneous camera devices with varying optical characteristics.

In Step 406, engine 200 activates localized scene detection algorithms to conduct preliminary analysis of the pre-processed frames. Leveraging embedded convolutional neural networks (CNNs) or transformer-based lightweight models, the system detects key scene elements such as human presence, object placement, environmental features, and gross motion patterns. These preliminary detection models, optimized for real-time edge execution, operate on devices like Wi-Fi access points or edge nodes within the network. Engine 200 coordinates model inference runs across multiple devices, balancing workloads to avoid network congestion and node overutilization. Scene detection output includes bounding box coordinates, classification labels, motion vectors, and temporal activity indicators, which are compiled and forwarded to higher-order processing modules within the local cluster.

According to some embodiments, such analysis in Steps 404 and 406 can be performed via the AI/ML techniques discussed above.

In Step 408, engine 200 implements advanced scene classification and contextual understanding by delegating more computationally intensive analysis to higher-capacity nodes within the local infrastructure—such as dedicated AI hubs, high-performance routers, or specialized edge compute appliances. This step can involve the application of deeper scene classification models capable of distinguishing between different environmental types (e.g., indoor vs. outdoor), identifying the functional characteristics of specific areas (e.g., lobby, kitchen, driveway), and detecting categories of human activities (e.g., resting, walking, interacting, trespassing). The engine 200 utilizes historical activity profiles, location metadata, and real-time environmental inputs to contextualize detected events within the broader behavioral patterns of the monitored environment. Additionally, scene anomaly detection routines are applied, where models identify deviations from learned norms, triggering elevated alert statuses for unusual behaviors or unexpected environmental changes.

In Step 410, engine 200 integrates advanced person identification functionality as a key component of Process 400. Utilizing multi-modal biometric inference pipelines, the engine conducts facial recognition, gait analysis, clothing signature identification, and behavioral pattern matching—all executed entirely within the local network. This step involves sophisticated deep learning models—such as ResNet or MobileFaceNets for facial embeddings, Recurrent Neural Networks (RNNs) or Graph Convolution Networks (GCNs) for behavioral analysis—operating on higher-tier computational devices. Engine 200 dynamically selects the optimal identification pathway based on current frame quality, visibility conditions, and privacy preferences. For example, in low-light scenarios where facial clarity is degraded, the system emphasizes gait and body posture analysis for person identification. In some embodiments, engine 200 can operate with strict privacy safeguards, generating ephemeral identity tokens (e.g., encrypted vector embeddings or anonymized identity signatures) that allow real-time person tracking and access validation without persisting raw biometric data within the network or transmitting it externally.

In Step 412, engine 200 synthesizes the scene detection and person identification outputs to generate actionable security insights and responses within the local monitoring system. This final stage involves multi-layered decision-making algorithms that evaluate the classification results, identification outputs, and contextual activity assessments to determine appropriate system actions. In some embodiments, engine 200 can trigger a spectrum of responsive behaviors, ranging from subtle user notifications (e.g., mobile alerts indicating known person arrival) to automated access control interventions (e.g., door lock engagement upon unauthorized entry), or escalated security protocols (e.g., audiovisual alarms during detected breaches). In some embodiments, engine 200 render these responses through integrated user interfaces including local dashboards, voice assistants, and connected security panels, ensuring immediate visibility of critical events without dependency on external services.

Throughout Steps 402-412, engine 200 can operate a real-time orchestration mechanisms that manage the elastic distribution of AI workloads. Such orchestration dynamically allocates tasks based on real-time CPU utilization, memory availability, thermal load metrics, and network congestion levels across the device ecosystem. By implementing a flexible processing hierarchy, engine 200 ensures that low-latency, essential detection tasks always remain operational, while more complex analytical processes are adaptively deferred or distributed during periods of high demand. This architecture guarantees optimal balance between system responsiveness and processing depth, aligning with stringent performance expectations of modern security environments.

In some embodiments, the privacy-centric architecture of Process 400 is embedded across all steps of the workflow. Engine 200 enforces strict local data confinement, preventing visual data or biometric identifiers from leaving the internal network boundary. Only abstracted or anonymized insights—such as event summaries, system performance metrics, or non-sensitive aggregate usage statistics—may be transmitted externally, typically in the context of federated learning updates or high-level administrative reporting. This design ensures compliance with evolving privacy regulations while addressing growing consumer expectations around data sovereignty and transparency in security operations.

In some embodiments, Process 400 can involve adaptive learning and personalization of the AI processing routines. Engine 200 incorporates federated learning capabilities where localized models incrementally adapt based on observed behavior patterns, recognized individuals, and environmental routines specific to the deployment location. Model updates are performed in a privacy-preserving manner, contributing anonymized parameter adjustments to broader knowledge pools without transmitting any local visual data. This mechanism allows the system to improve person identification accuracy, reduce false positives in scene anomaly detection, and fine-tune scene classification logic in alignment with household-specific or business-specific operational profiles.

In some embodiments, engine 200 also incorporates multi-camera correlation logic, wherein data streams from multiple independent camera devices are aggregated to provide a unified situational awareness model. By cross-referencing activity patterns across spatially separated viewpoints, the system improves tracking continuity, enhances detection confidence, and minimizes false alarms commonly associated with isolated camera analysis. Such multi-camera awareness enables the framework to provide area-wide tracking and behavior mapping, supporting complex use cases such as facility security, retail environment monitoring, and perimeter intrusion detection.

Additionally, Process 400 supports real-time resource conservation strategies. Engine 200 continuously monitors the operational load on critical network devices (e.g., Wi-Fi access points doubling as AI compute nodes), dynamically scaling back AI task intensity during periods of high network utilization for core functions like internet connectivity or media streaming. This ensures that essential services remain unaffected while the AI layer opportunistically utilizes surplus capacity during idle or low-demand periods. The engine can also prioritize critical monitoring zones—such as entry points or sensitive areas—ensuring continuous coverage even under constrained resource availability.

Overall, through Steps 402 through 412, Process 400 delivers a highly resilient, adaptive, and privacy-forward security framework that elevates conventional monitoring systems into intelligent, autonomous platforms. Engine 200's ability to orchestrate elastic, localized AI resources enables granular real-time scene understanding and person identification while respecting privacy boundaries, eliminating external data dependencies, and dynamically adapting to each unique deployment environment.

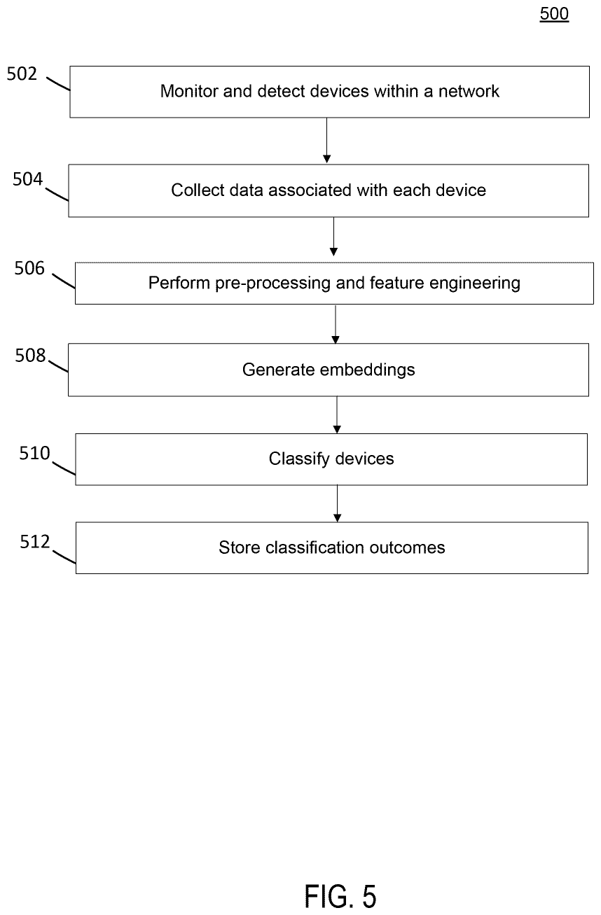

Turning to FIG. 5, Process 500 provides non-limiting example embodiments for device classification using a distributed, edge AI architecture. As discussed herein, in some embodiments, engine 200 utilizes advanced AI-based device profiling techniques and elastic edge resource allocation strategies to classify connected devices (e.g., into child or adult user categories) without transmitting sensitive behavioral data to external cloud environments.

According to some embodiments, Steps 502 and 504 of Process 500 can be performed by identification module 202 of network engine 200; Step 506 can be performed by analysis module 204; Steps 508 and 510 can be performed by determination module 206; and Step 512 can be performed by output module 208.

According to some embodiments, Process 500 begins with Step 502 where engine 200 function to continuously (or periodically, as discussed supra) monitor network activity to detect active devices connected within the local environment, such as a household, office, or other defined network zone. In some embodiments, using deep packet inspection (DPI) techniques and lightweight device discovery protocols, engine 200 aggregates metadata such as MAC addresses, device manufacturer information, DHCP-assigned device names, and network interface characteristics. Such initial discovery phase allows engine 200 to generate a preliminary device inventory in real time without introducing latency or interrupting network performance.

In some embodiments, engine 200 can leverage existing Wi-Fi access points, mesh nodes, and set-top boxes to perform distributed detection. Such devices, acting as decentralized sensor nodes, report activity logs to a local orchestration mechanism that consolidates device presence events, connection timeframes, and session durations. By operating entirely within the local network, Engine 200 ensures that no sensitive device-identifying data is transmitted beyond the premises.

In Step 504, engine 200 initiates behavioral data collection associated with each detected device, generating a rich dataset that forms the basis for behavioral profiling and classification. Behavioral data includes internet access patterns (e.g., accessed domains, DNS requests), application usage metadata (e.g., inferred from server name indication (SNI) inspection or deep flow analysis), time-of-day activity patterns, traffic volumes (upload and download), and session duration metrics.

In some embodiments, engine 200 configures local edge devices (e.g., mesh routers) to collect this data at systematic intervals (e.g., every 15 minutes), with retention settings enabling one week or more of rolling data capture. Such comprehensive data lake provides both high-resolution short-term data and sufficient historical depth to identify longer-term behavioral trends.

In some embodiments, engine 200 can access device type classifications (e.g., iOS, Android, gaming console, smart TV), further enriching the behavioral context with device-type signatures.

In Step 506, engine 200 processes the raw collected data locally using optimized preprocessing pipelines. Such preprocessing mechanism normalizes and structures data points into a standardized schema suitable for AI/ML inference. Feature engineering processes extract meaningful vectors such as, but not limited to, application category distributions (e.g., percentage of time on streaming services vs. educational content); time-of-day engagement histograms; domain diversity (entropy of visited domains); session burstiness (clustered vs. evenly spread activity); latency-sensitive vs. bulk transfer ratio analysis, and the like.

In some embodiments, using lightweight AI accelerators (if available) or multi-core CPU resources on devices like mesh routers, Engine 200 executes feature extraction without reliance on external data centers.

In Step 508, engine 200 applies localized machine learning models, including pre-trained lightweight embedding models (e.g., MiniLM or similar small-footprint language models adapted for structured data), to convert engineered behavioral features into high-dimensional vector embeddings. In some embodiments, each device can be represented by a vector encapsulating semantic behavioral characteristics across multiple dimensions such as, but not limited to: application engagement semantics; activity timing regularity; consumption category balance, contextual usage patterns (weekday vs. weekend behavior), and the like. In some embodiments, the embeddings can be generated on-device or distributed across multiple local nodes using containerized inference engines, ensuring computational loads are elastically balanced across the network.

In Step 510, engine 200 applies supervised classification algorithms—such as neural networks, gradient-boosted decision trees, or transformer-based classifiers—to assign probabilistic classifications to each device embedding. In some embodiments, such classification output includes, but is not limited to, probability scores for each user profile (e.g., child vs. adult); confidence levels derived from the underlying classifier softmax or margin scores; associated rationale derived from interpretable AI modules, and the like.

In some embodiments, such classification tasks can be executed within the local edge cluster to maintain privacy, with computation dynamically routed to higher-capacity nodes (e.g., set-top boxes or mesh backhaul nodes) depending on availability. In some embodiments, engine 200 can use adaptive thresholding logic to tune classification decision boundaries in real time, accounting for confidence scores, recent feedback (if available), and operational requirements (e.g., child safety policies).

According to some embodiments, such analysis in Steps 504-510 can be performed via the AI/ML techniques discussed above.

In Step 512, engine 200 securely stores classification outcomes within a privacy-preserving local data lake. Device profiles, including classification tags (e.g., “Child Device,” “Adult Device”), are maintained alongside temporal behavioral embeddings, enabling future trend detection and behavioral drift monitoring. In some embodiments, such storage system uses encrypted partitioned storage per device, ensuring data segregation and security compliance. Older data is intelligently aggregated to maintain long-term trends while minimizing storage overhead (e.g., down-sampling daily summaries after several weeks).

In some embodiments, Step 512 can trigger adaptive system actions, such as, but not limited to: dynamic content filtering policies based on classification status; user interface (UI) adjustments (e.g., parental dashboards for parental controls, as discussed supra); selective device access controls (e.g., parental controls limiting gaming console access based on classification confidence and time-of-day); continuous learning updates where user feedback or classification corrections are logged to fine-tune future inferences, and the like, or some combination thereof.

In some embodiments, engine 200 can integrate federated learning mechanisms, whereby anonymized statistical gradients are shared (if permitted) with broader model repositories to improve global classifier robustness, all while ensuring no raw behavioral data or sensitive identity markers leave the local network boundary.

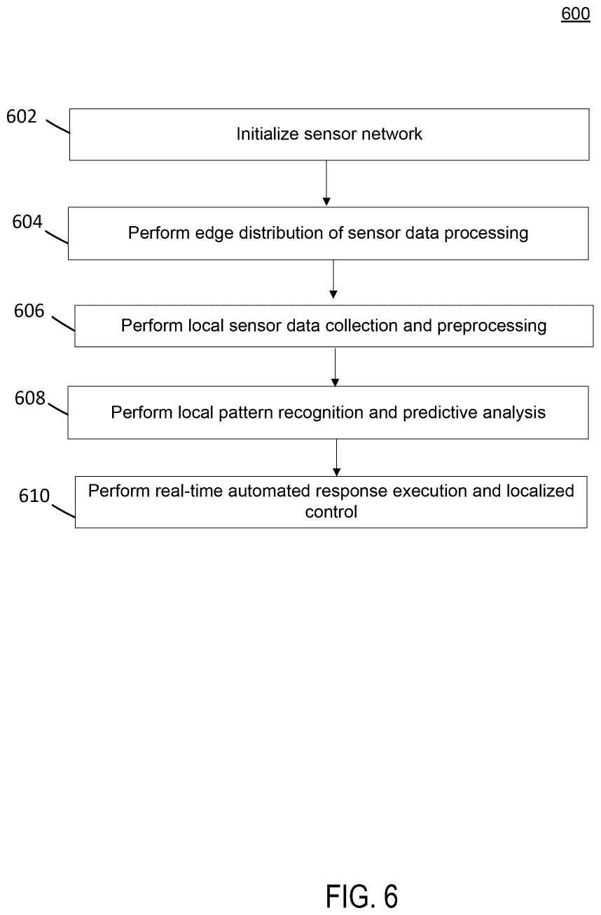

Turning to FIG. 6, Process 600 provides non-limiting example embodiments for sensor network operations and management via distributed edge AI functionality, as discussed herein..

According to some embodiments, Step 602 of Process 600 can be performed by identification module 202 of network engine 200; Steps 604 and 606 can be performed by analysis module 204; Step 608 can be performed by determination module 206; and Step 610 can be performed by output module 208.

According to some embodiments, Process 600 begins with Step 602 where engine 200 can initiate the creation of a comprehensive wireless sensor network by leveraging the existing home or office network infrastructure, eliminating the need for cloud dependencies. This initialization process involves the auto-detection and registration of a plurality of wireless sensors, which may include window and door sensors, temperature sensors, motion detectors, light sensors, and camera-based security systems. Upon power-on or installation, each sensor transmits an initialization beacon, which is received by proximal Wi-Fi access points or mesh network nodes operating within the location.

In some embodiments, engine 200 utilizes standardized low-power wireless protocols, such as, for example, ZigBee, Thread, Bluetooth Low Energy (BLE), or Wi-Fi HaLow, to facilitate sensor onboarding. The registration protocol authenticates each sensor via secure handshake procedures (e.g., public/private key exchanges), ensuring only authorized sensors are enrolled into the trusted local sensor network. Once authenticated, the sensors are assigned unique network identifiers and logical grouping labels (e.g., security cluster, environmental cluster, occupancy cluster) enabling optimized downstream processing.

In some embodiments, engine 200 maps the physical topology of the sensor network by assessing wireless signal strengths, proximity to network nodes, and available energy harvesting features (if applicable), creating a sensor topology map that informs routing and processing decisions in subsequent steps.

In Step 604, engine 200 deploys elastic edge sensor processing, where the computational workloads related to sensor data ingestion, preprocessing, analysis, and response generation are dynamically allocated across a distributed cluster of network devices within the local environment.

According to some embodiments, such orchestration mechanisms identify available computational resources —such as Wi-Fi access points, mesh repeaters, smart home hubs, and other edge AI capable devices —evaluating their CPU capacity, RAM availability, power source (battery-powered or AC-powered), and network connectivity. Using real-time resource monitoring and device capability profiling, the system determines optimal node assignments for specific types of processing tasks.

In some embodiments, by way of non-limiting example: low-complexity filtering and time-series data aggregation tasks are allocated to lower-tier nodes (e.g., mesh nodes); intermediate processing, such as environmental trend detection or occupancy state determination, is assigned to mid-tier AC-powered devices (e.g., smart hubs); high-complexity inferential tasks, such as anomaly detection, pattern recognition, and predictive modeling, are routed to high-performance nodes like dedicated AI gateways or AI-enabled access points; and the like.

Accordingly, in some embodiments, such elastic edge distribution allows the framework to dynamically scale as new devices join or exit the network, seamlessly redistributing workloads while maintaining real-time responsiveness.

In Step 606, engine 200 can operate to perform (continuous and/or periodic) data collection cycles, where each sensor transmits data packets at intelligently scheduled intervals based on event triggers, time-based sampling, or pre-configured periodicity (e.g., every 15 minutes). In some embodiments, to conserve power in battery-operated sensors, engine 200 can utilize adaptive duty cycling and event-triggered wake-up patterns. For example, door/window sensors transmit only upon state change, while temperature sensors transmit aggregated rolling averages to avoid redundant data.

In some embodiments, upon receiving sensor data, engine 200 can cause edge nodes to perform initial preprocessing, which can include, but is not limited to: data validation (e.g., checksum verification); outlier detection to filter corrupted or nonsensical readings; temporal normalization to synchronize asynchronous sensor events into coherent temporal windows; data compression utilizing lightweight lossless algorithms (e.g., LZ4) to optimize bandwidth usage during multi-hop transmissions to processing nodes, and the like. In some embodiments, through this preprocessing phase, engine 200 can ensure data consistency, reduces network congestion, and prepares the data for real-time analytical processing.

In Step 608, engine 200 can execute advanced pattern recognition and predictive analysis directly within the local network, bypassing any need for cloud-based inference services. In some embodiments, historical sensor data is stored in a distributed, encrypted local data lake architecture, where each participating edge device maintains segments of the overall dataset with redundancy mechanisms in place to prevent data loss. For example, using lightweight machine learning models (e.g., decision trees, shallow neural networks, or transformer micro-models), engine 200 can perform, but not be limited to: time-series forecasting (e.g., predicting occupancy based on prior patterns); anomaly detection (e.g., detecting open doors during scheduled unoccupied periods); predictive maintenance triggers (e.g., detecting abnormal battery drain in specific sensors indicating possible faults), and the like.

In some embodiments, engine 200 can integrate cross-sensor correlation techniques, fusing inputs from heterogeneous sensor modalities (e.g., correlating temperature shifts with door state transitions) to provide enriched contextual understanding, thereby improving the accuracy and robustness of environmental predictions.

In Step 610, engine 200 can utilize the results from local analysis to trigger automated responses within the location (e.g., home or office environment, for example). In some embodiments, this can involve integration with home automation systems, such as smart thermostats, HVAC controllers, lighting systems, security alarms, and other IoT devices capable of receiving local network commands.

In some embodiments, such response execution operates under a dynamically determined, automatically determined and/or predetermined rule-based policy engine augmented by AI-driven decision modulation. For example: a detected occupancy state can trigger adaptive climate control adjustments to optimize comfort and energy savings; a door sensor indicating prolonged open status during high-temperature periods can prompt alerts and fan adjustments to prevent HVAC inefficiency; anomalous multi-sensor readings (e.g., simultaneous motion detection in a normally inactive zone during scheduled away periods) can trigger a localized alarm without cloud involvement, preserving response latency within milliseconds; and the like.

In some embodiments, to ensure adaptability, engine 200 can employ reinforcement learning mechanisms where user overrides (e.g., manual thermostat adjustments) are logged and used to retrain local response policies, incrementally improving personalization. In some embodiments, engine 200 can incorporates fail-safe protocols—should the primary processing node go offline, redundant nodes are pre-configured to take over decision-making responsibilities, ensuring continuous operation.

According to some embodiments, engine 200's sensor network capabilities can extend to operational detail, which can include auxiliary functions, as discussed herein:

### Sensor Power Optimization

In some embodiments, the framework (e.g., engine 200) applies dynamic transmission scheduling based on network bandwidth and energy harvesting status (e.g., solar-powered sensors increase reporting frequency during daylight). It tracks nanowatt-hour level energy consumption metrics to adjust sensor sampling rates without compromising responsiveness.

### Privacy-Preserving Architecture

In some embodiments, no raw sensor data leaves the local network boundary. Aggregated statistics and anonymized metadata may be selectively transmitted to external devices (e.g., the user's phone) only for non-sensitive notifications. End-to-end encryption and decentralized data isolation protocols prevent internal data cross-leakage among sensors.

### Self-Healing Network Behavior

In some embodiments, using mesh networking principles, the system reroutes traffic in case of local link degradation and deploys opportunistic synchronization whereby intermittent sensors (e.g., low-battery devices) can store and forward data opportunistically without loss of historical context.

### Adaptive User Feedback Loop

In some embodiments, through integration with user interface applications, the framework collects explicit feedback (e.g., “temperature too high”), which is stored locally and used to auto-adjust future automated behavior through reinforcement learning models, adapting not only to patterns but to evolving user preferences.

Accordingly, as discussed supra, Steps 602-610 of Process 600 provide functionality for a localized, privacy-respecting, intelligent sensor network framework that offers cloud-independent environmental control, proactive energy optimization, and enhanced responsiveness in home or office environments. Such processing and functionality revolutionizes traditional smart home systems by offering resilient, low-latency, and highly adaptive behavior driven entirely by local computation.

FIG. 9 is a schematic diagram illustrating a client device 900 showing an example embodiment of a client device that may be used within the present disclosure. Client device 900 may include many more or less components than those shown in FIG. 9. However, the components shown are sufficient to disclose an illustrative embodiment for implementing the present disclosure. Client device 900 may represent, for example, UE 102 discussed above at least in relation to FIG. 1.

As shown in the figure, in some embodiments, Client device 900 includes a processing unit (CPU) 922 in communication with a mass memory 930 via a bus 924. Client device 900 also includes a power supply 926, one or more network interfaces 950, an audio interface 952, a display 954, a keypad 956, an illuminator 958, an input/output interface 960, a haptic interface 962, an optional global positioning systems (GPS) receiver 964 and a camera(s) or other optical, thermal or electromagnetic sensors 966. Device 900 can include one camera/sensor 966, or a plurality of cameras/sensors 966, as understood by those of skill in the art. Power supply 926 provides power to Client device 900.

Client device 900 may optionally communicate with a base station (not shown), or directly with another computing device. In some embodiments, network interface 950 is sometimes known as a transceiver, transceiving device, or network interface card (NIC).

Audio interface 952 is arranged to produce and receive audio signals such as the sound of a human voice in some embodiments. Display 954 may be a liquid crystal display (LCD), gas plasma, light emitting diode (LED), or any other type of display used with a computing device. Display 954 may also include a touch sensitive screen arranged to receive input from an object such as a stylus or a digit from a human hand.

Keypad 956 may include any input device arranged to receive input from a user. Illuminator 958 may provide a status indication and/or provide light.

Client device 900 also includes input/output interface 960 for communicating with external. Input/output interface 960 can utilize one or more communication technologies, such as USB, infrared, Bluetooth™, or the like in some embodiments. Haptic interface 962 is arranged to provide tactile feedback to a user of the client device.

Optional GPS transceiver 964 can determine the physical coordinates of Client device 900 on the surface of the Earth, which typically outputs a location as latitude and longitude values. GPS transceiver 964 can also employ other geo-positioning mechanisms, including, but not limited to, triangulation, assisted GPS (AGPS), E-OTD, CI, SAI, ETA, BSS or the like, to further determine the physical location of client device 900 on the surface of the Earth. In an embodiment, however, client device 900 may through other components, provide other information that may be employed to determine a physical location of the device, including for example, a MAC address, Internet Protocol (IP) address, or the like.

Mass memory 930 includes a RAM 932, a ROM 934, and other storage means. Mass memory 930 illustrates another example of computer storage media for storage of information such as computer readable instructions, data structures, program modules or other data. Mass memory 930 stores a basic input/output system (“BIOS”) 940 for controlling low-level operation of Client device 900. The mass memory also stores an operating system 941 for controlling the operation of Client device 900.

Memory 930 further includes one or more data stores, which can be utilized by Client device 900 to store, among other things, applications 942 and/or other information or data. For example, data stores may be employed to store information that describes various capabilities of Client device 900. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 900.

Applications 942 may include computer executable instructions which, when executed by Client device 900, transmit, receive, and/or otherwise process audio, video, images, and enable telecommunication with a server and/or another user of another client device. Applications 942 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In some embodiments, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
monitoring, by an application executing on a device among a plurality of connected devices at a location, for an event, the monitoring comprising detecting the event corresponding to capturing of an associated set of video frames and metadata from at least one of the connected devices;
processing, by the application, the captured set of video frames locally using at least one computer vision model to detect objects and at least one large language model (LLM) to perform contextual reasoning;
generating, by the application, a structured query based on the detected objects and contextual reasoning; and
causing display, within a user interface (UI) displayed by at least one of the connected devices, contextually relevant information derived from a response to the structured query.

2. The method of claim 1, wherein processing includes pre-processing the video frames by applying one or more of noise reduction, deblurring, or color correction.

3. The method of claim 1, wherein the LLM performs semantic analysis to determine object functions, interpersonal relationships, or environmental context.

4. The method of claim 1, wherein the structured query excludes raw image data and comprises abstracted scene descriptors.

5. The method of claim 1, further comprising:
communicating the query to a network resource; and
receiving the contextually relevant information.

6. The method of claim 1, further comprising dynamically allocating processing workloads across the connected devices based on resource availability.

7. The method of claim 1, wherein the contextually relevant information is rendered within the UI via a display overlay, interactive popup or mobile notification.

8. The method of claim 1, wherein the response to the structured query is post-processed locally to filter and prioritize information based on user preferences.

9. The method of claim 1, wherein the location hosts a network that is a Wi-Fi network.

10. A device comprising:
a processor; and
memory tangibly storing computer instructions, that when executed, cause the processor to:
monitor, by an application executing on the device among a plurality of connected devices at a location, for an event, the monitoring comprising detecting the event corresponding to capturing of an associated set of video frames and metadata from at least one of the connected devices;
process, by the application, the captured set of video frames locally using at least one computer vision model to detect objects and at least one large language model (LLM) to perform contextual reasoning;
generate, by the application, a structured query based on the detected objects and contextual reasoning; and
cause display, within a user interface (UI) displayed by at least one of the connected devices, contextually relevant information derived from a response to the structured query.

11. The device of claim 10, wherein processing includes pre-processing the video frames by applying one or more of noise reduction, deblurring, or color correction.

12. The device of claim 10, wherein the LLM performs semantic analysis to determine object functions, interpersonal relationships, or environmental context.

13. The device of claim 10, wherein the structured query excludes raw image data and comprises abstracted scene descriptors.

14. The device of claim 10, wherein the processor is further configured to:
communicate the query to a network resource; and
receive the contextually relevant information.

15. The device of claim 10, wherein the processor is further configured to dynamically allocate processing workloads across the connected devices based on resource availability.

16. The device of claim 10, wherein the contextually relevant information is rendered within the UI via a display overlay, interactive popup or mobile notification.

17. The device of claim 10, wherein the response to the structured query is post-processed locally to filter and prioritize information based on user preferences.

18. A non-transitory computer-readable storage medium tangibly encoded with computer-executable instructions, that when executed by a device, perform a method comprising:
monitoring, by an application executing on the device among a plurality of connected devices at a location, for an event, the monitoring comprising detecting the event corresponding to capturing of an associated set of video frames and metadata from at least one of the connected devices;
processing, by the application, the captured set of video frames locally using at least one computer vision model to detect objects and at least one large language model (LLM) to perform contextual reasoning;
generating, by the application, a structured query based on the detected objects and contextual reasoning; and
causing display, within a user interface (UI) displayed by at least one of the connected devices, contextually relevant information derived from a response to the structured query.

19. The non-transitory computer-readable storage medium of claim 18, wherein the LLM performs semantic analysis to determine object functions, interpersonal relationships, or environmental context.

20. The non-transitory computer-readable storage medium of claim 18, further comprising dynamically allocating processing workloads across the connected devices based on resource availability.
